(19) United States
(12) Patent Application Publication
(10) Pub. No.: US 2026/0236481 A1
(43) Pub. Date: Aug. 13, 2026

(54) DATA ANALYSIS AGENT SYNTHESIZING RESPONSES FROM EXPERIENCE DATA USING LARGE LANGUAGE MODELS

(71) Applicant: Qualtrics, LLC, Provo, UT (US)

(72) Inventors: Mustafa Ozdayi, Seattle, WA (US); Rajat Agarwal, Kirkland, WA (US); Michael Page, Provo, UT (US); Sean Bergam, Midvale, UT (US); Andrew Jewsbury, Seattle, WA (US); Benjamin McCabe, Dublin (IE); Yashmeet Gambhir, Seattle, WA (US); Loma Desai, Redmond, WA (US); Zayd Hammoudeh, Seattle, WA (US); Daniel Alexander Saunders, Dublin (IE)

(21) Appl. No.: 19/051,808

(22) Filed: Feb. 12, 2025

(51) Int. Cl. G06F 16/248; G06F 40/40

(52) U.S. Cl. CPC G06F 16/248; G06F 40/40

(57) ABSTRACT

The present disclosure relates to systems, non-transitory computer-readable media, and methods for utilizing a large language model to synthesize a response using experience data of a user account of an experience management system. In particular, in one or more embodiments, the disclosed systems receive a request at a data analysis agent of the experience management system and select a set experience data based on the request. The disclosed systems then provide the set of experience data and the request to a response synthesis large language model to generate a synthesized response. In some embodiments, the disclosed systems generate data embeddings from experience data and select the set of experience data based on compare the data embeddings to the request to synthesize the response.

### BACKGROUND

Recent years have seen significant improvements in generating and providing data visualizations and analytical insights from experience data. For example, conventional systems gather, store, and generate visualizations of data from various sources to provide a comprehensive overview of user experiences concerning a specific system, product, or service. To illustrate, conventional systems utilize digital surveys within which a respondent can provide various types and modes of feedback, extract and analyze data from online locations where users of systems, products, or services provide unstructured feedback (e.g., social media posts, website reviews), or from transcripts of interactions with agents of a system, product, or service. Indeed, with this comprehensive digital feedback data, conventional systems can provide insights for improving individual products and services as well as the overall systems that provide the products and services. Despite their many advancements, conventional systems have several deficiencies regarding accuracy, efficiency, and flexibility, especially when generating insights from digital feedback data.

For instance, conventional systems are inefficient. As mentioned, conventional systems store vast amounts of digital feedback data collected from many devices located all over the world. Many existing systems generate and provide visual representations of these collected experience data in the form of graphs or charts, providing filtering tools and other visualization options to modify representations of and/or locate particular data. Beyond rudimentary visualizations, however, many existing systems provide no further depth of insight or intelligent analysis of experience data, instead relying on user navigation and savvy to identify correct data, interact with filtering tools, and change visualizations, often through rendering and closing various interfaces as users interact with all of the options and elements provided. This unguided process needlessly requires excessive interactions with client devices and excessive resource allocation and setup time to render interfaces (e.g., memory for caching interfaces and all of their elements), in addition to the resource cleanup required when closing the interfaces. In addition, repeatedly querying large datasets with these unguided systems often results in poorly optimized queries, which results in high latency and slower response times.

In addition to being inefficient, many conventional systems are inflexible. For example, conventional systems often display digital feedback data within interfaces, but they only provide specific preset visualizations (e.g., particular formats of graphs and charts) relating to the digital feedback data. Conventional systems display aggregate or straightforward calculations of the digital feedback data, displaying information based on pre-built systems that thus require additional analysis on the part of the user to ascertain what certain data indicates or how one set of data relates to another. Moreover, because conventional systems use prebuilt systems with a limited number of visualization options, such systems cannot translate data into actionable recommendations that require data interpretation beyond mere presentation.

On top of their inflexibilities and inefficiencies, many conventional systems are inaccurate. Specifically, conventional systems can generate suggestions provide graphical visualizations of collected data, with some existing systems providing rudimentary capabilities for data insights that describe graphical data in words. Such systems provide high level descriptions based on feedback data without any in-depth analysis of data patterns, contextual information from particular entities, or historical information from past surveys included in feedback data. Indeed, conventional systems often simply link to articles that relate to generally making improvements or general trends seen in a type of experience data relating to the product good or service, rather than parsing the experience data to generate intelligent responses. These, along with additional problems and issues, exist with regard to conventional systems.

### SUMMARY

Embodiments of the present disclosure provide benefits and/or solve one or more of the foregoing or other problems in the art with systems, non-transitory computer-readable media, and methods for utilizing machine learning approaches to synthesize responses for requests received at data analysis agents using experience data of an experience management system. For example, the disclosed systems select user-account-specific experience data from experience data stored in (or for) dashboard widgets of the experience management system and utilize a large language model to synthesize a response for the request based on the selected experience data. In some embodiments, the disclosed systems generate embeddings corresponding to various types of widgets and select experience data based on comparing the embeddings to the request to synthesize the response. In addition, in some embodiments, the disclosed systems provide the synthesized response on a client device together with a storage location, or widget, within the experience management system for experience data, the large language model used to synthesize the response. Additional features and advantages of one or more embodiments of the present disclosure are outlined in the description that follows and, in part, will be obvious from the description or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example diagram of an overview of a response synthesis system utilizing a response synthesis large language model to synthesize a response using experience data of a user account of an experience management system in accordance with one or more embodiments.

FIG. 2 illustrates a schematic diagram of a response synthesis system selecting a set of experience data based on comparing a request to generate a synthesized response to data embeddings in accordance with one or more embodiments.

FIG. 3 illustrates a schematic diagram of a response synthesis system selecting experience data based on semantic similarity between a request and data embeddings associated with the experience in accordance with one or more embodiments.

FIG. 4 illustrates a schematic diagram of a response synthesis system generating a prompt comprising a set of experience data and response categories in accordance with one or more embodiments.

FIG. 5 illustrates a schematic diagram of a response synthesis system receiving an additional request to generate a synthesized response generating a prompt with an updated set of experience data in accordance with one or more embodiments.

FIG. 6 illustrates a schematic diagram of a response synthesis system utilizing large language models to generate computer-executable instructions to perform mathematical computations for experience data and synthesizing a response using the mathematical computations in accordance with one or more embodiments.

FIGS. 7A-7B illustrate example graphical user interfaces for receiving a request to generate a synthesized response and for displaying source experience data in accordance with one or more embodiments.

FIGS. 8A-8B illustrate example graphical user interfaces for receiving user selections of experience data from which a response synthesis system can select a set of experience data to synthesize a response in accordance with one or more embodiments.

FIG. 9 illustrates a diagram of an environment in which a response synthesis system can operate in accordance with one or more embodiments.

FIG. 10 illustrates a flowchart of a series of acts for utilizing a large language model to generate a synthesized response using experience data of a user account of an experience management system in accordance with one or more embodiments.

FIG. 11 illustrates a block diagram of an example computing device for implementing one or more embodiments of the present disclosure.

FIG. 12 illustrates a network of an experience management system in accordance with one or more embodiments.

### DETAILED DESCRIPTION

This disclosure describes one or more embodiments of a response synthesis system that utilizes a large language model to generate a synthesized response using experience data of a user account of an experience management system. Specifically, in response to receiving a request to synthesize a response, the response synthesis system selects experience data associated with a user account of the experience management system. In some cases, the response synthesis system generates embeddings from experience data stored in dashboard widgets (or in server database locations associated with dashboard widgets) of the experience management system and selects experience data based on comparing the embeddings to the request to synthesize the response. The response synthesis system then provides the selected experience data to a large language model to generate the synthesized response and provides the response for display on a client device associated with the user account. In some instances, the response synthesis system provides a storage location (or widget) storing experience data to the large language used to synthesize the response.

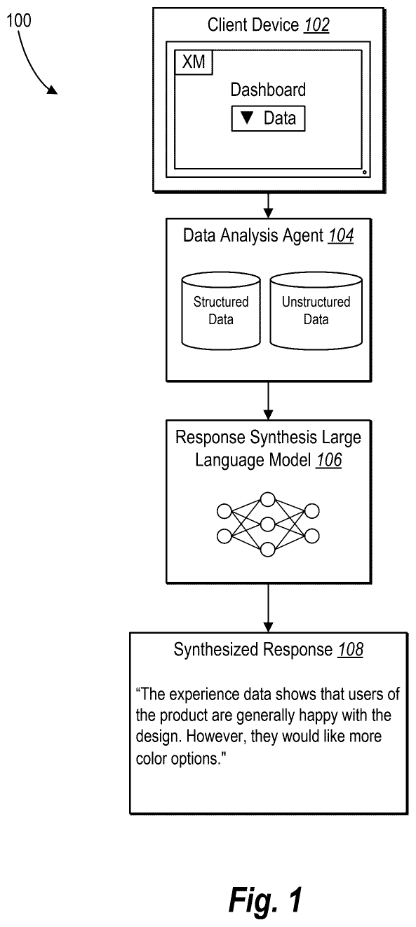

FIG. 1 illustrates an example overview of a response synthesis system 100 utilizing a response synthesis large language model 106 to synthesize a response to a request in accordance with one or more embodiments. As shown in FIG. 1, the response synthesis system 100 receives a user interaction indicating a request to synthesize a response from the client device 102. In particular, client device 102 is associated with a user account of an experience management system and the user interaction requests the response synthesis system 100 to synthesize a response using experience data associated with the user account. For example, a request can include a request to generate a summary of experience data, ask a question about experience data, or request a suggestion (or action item) based on experience data.

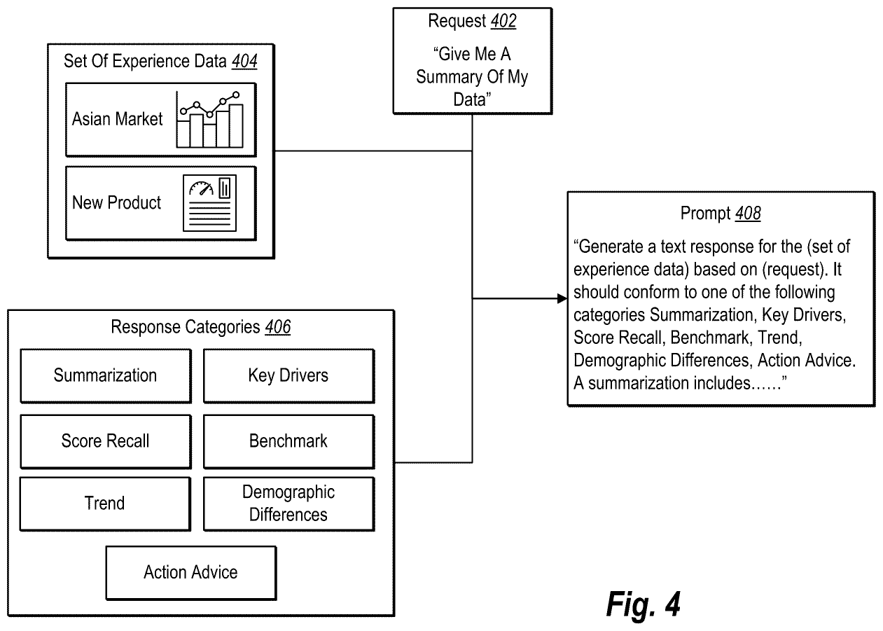

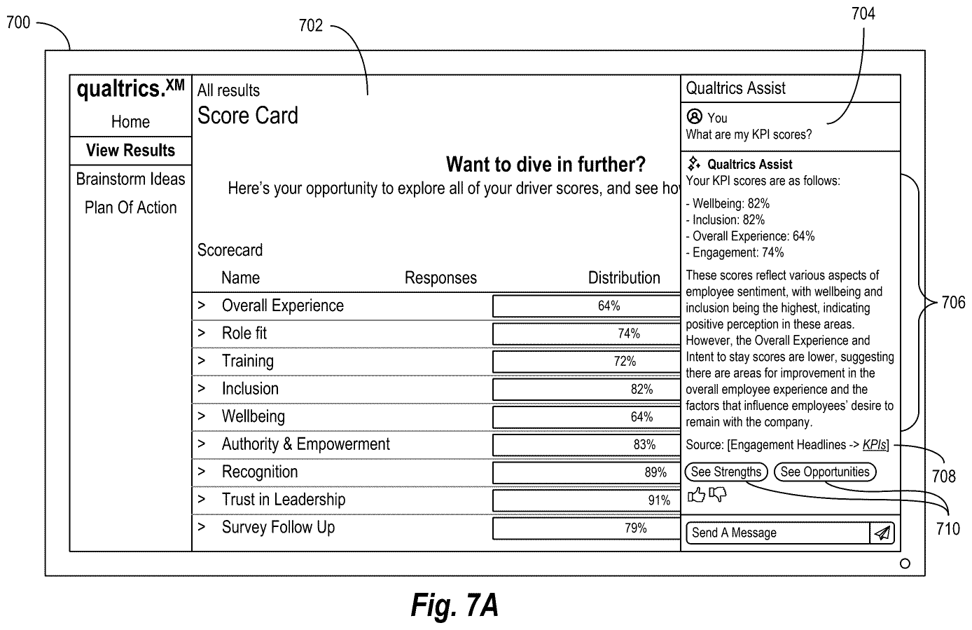

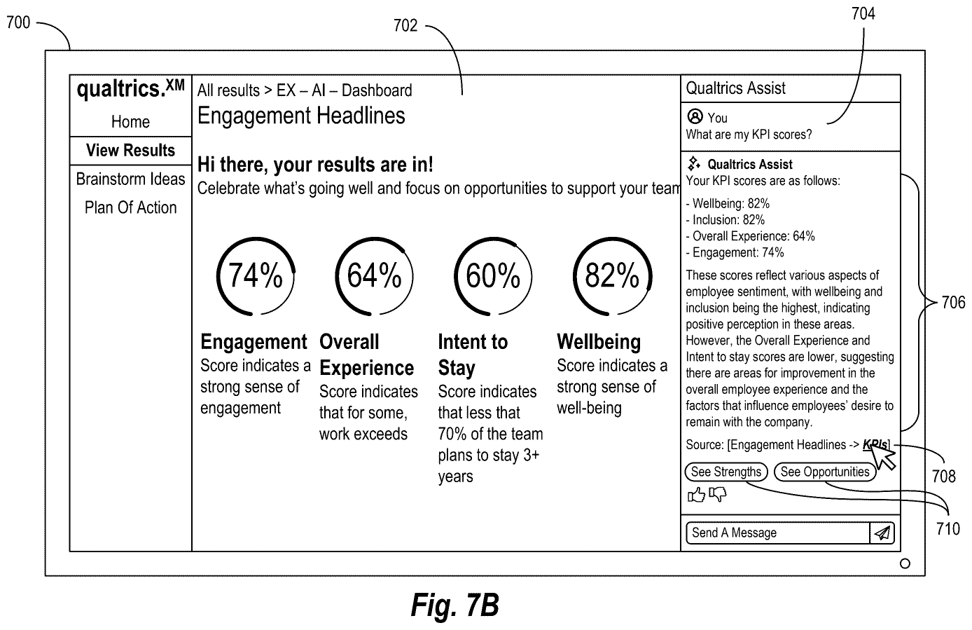

As also shown, the response synthesis system 100 provides request to a data analysis agent 104. Specifically, data analysis agent 104 is integrated within (or connected to) an experience management system and receives requests to generate synthesized responses. For example, based on receiving the request at data analysis agent 104, the response synthesis system 100 selects a set of experience data (indicated by or otherwise corresponding to the request) and generates a prompt for a response synthesis large language model 106, including (a summary of or an indication to access) the selected experience data and instructions to generate a synthesized response using the experience data. In some cases, the response synthesis system 100 also includes response categories and instructions in the prompt to synthesize a response conforming to one of the response categories. Additional details regarding the response synthesis system 100 generating a prompt are provided below with respect to FIG. 4. Further, additional details and examples of graphical user interfaces associated with a data analysis widget are provided below with respect to FIGS. 7A-7B.

As mentioned, in one or more embodiments, the response synthesis system 100 uses data analysis agent 104 to select experience data from experience data stored within the experience management system. Specifically, the response synthesis system 100 selects experience data from structured experience data and unstructured experience data stored by the experience management system. For example, the experience management system stores structured data representing structured answers from a digital survey, such as selections of predefined answers to close-ended survey questions of a digital survey or other data that can be tabulated and stored in tabular data structures or arrays. The experience management system can also store unstructured experience data representing unstructured answers from a digital survey, such as open-ended questions where a respondent freely inputs text in response to a prompt of the digital survey or other data that cannot be tabulated or stored in tabular data structures or arrays.

In some embodiments, the response synthesis system 100 the response synthesis system 100 utilizes data analysis agent 104 uses a retrieval augmented generation (“RAG”) approach to access experience data associated with widgets of an experience management system. Specifically, response synthesis system 100 can access structured experience data stored in data storage associated with tabular widgets and access unstructured data stored in data storage associated with comment widgets. In some cases, the response synthesis system 100 selects experience data based on user selections of options within a widget. For instance, if a user selection selects a portion of experience data (e.g., experience data from a certain geographical area), the data analysis agent 104 selects experience data from the selected portion of experience data.

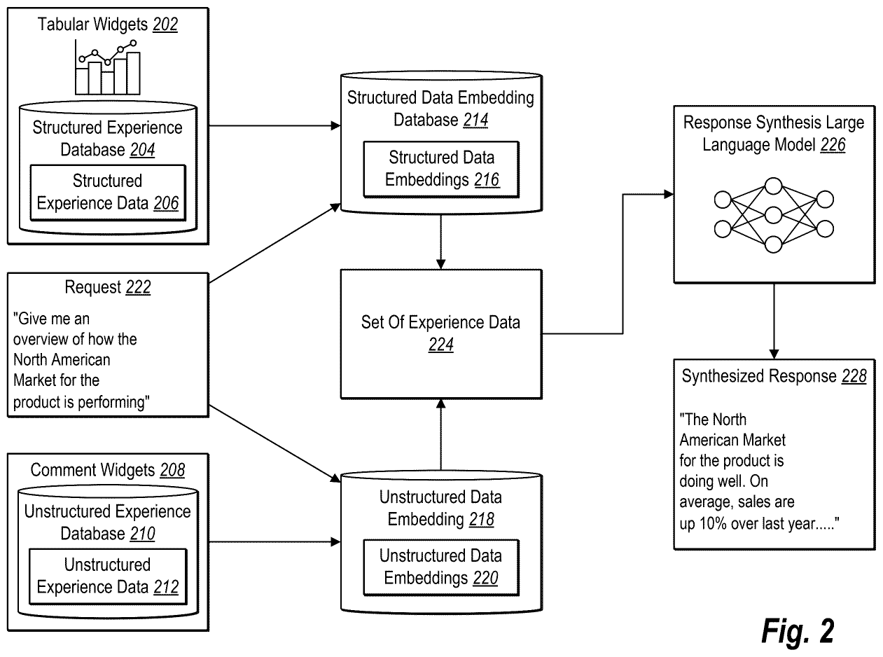

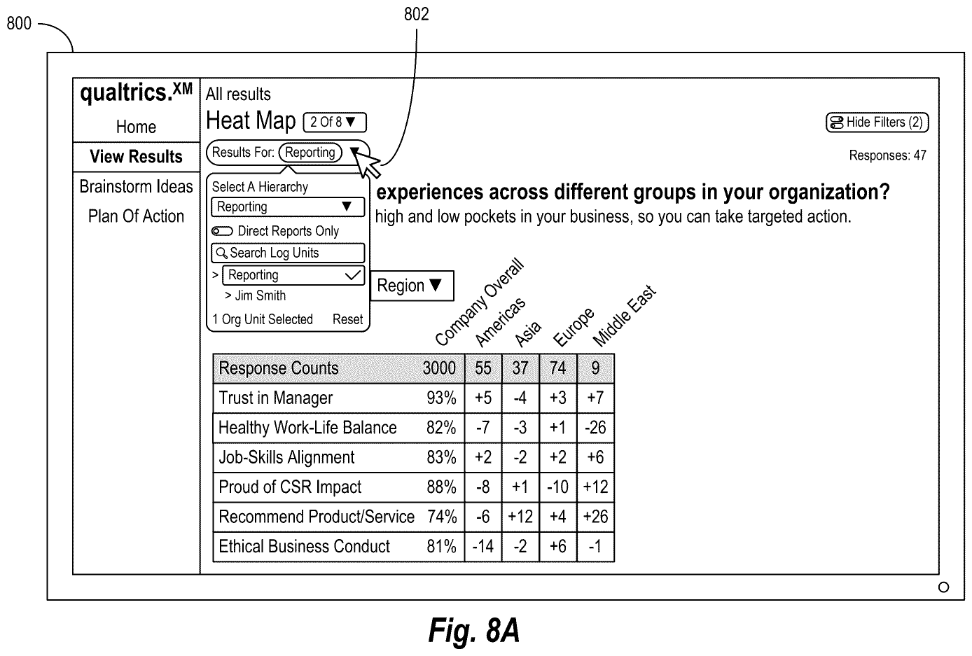

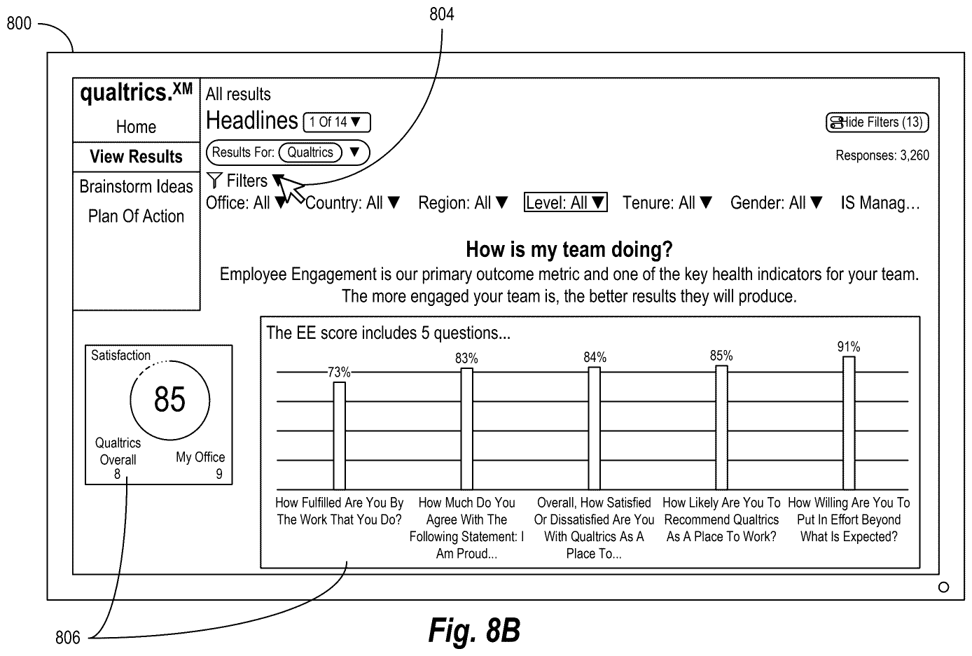

Continuing the RAG approach, in one or more embodiments, the response synthesis system 100 utilizes data analysis agent 104 to select experience data based on comparing data embeddings extracted from the experience data to the request to synthesize the response (e.g., through augmentation of a large language model via extracted data). Specifically, the response synthesis system 100 generates data embeddings from experience data. In response to receiving the request to synthesize a response, the response synthesis system 100 compares the data embeddings to the request and selects a set of experience data. For example, after comparing the data embeddings to the request, the response synthesis system 100 selects a k number of data embeddings (e.g., based on a ranking or score) and selects the experience data corresponding to the data embeddings to provide the response synthesis large language model to synthesize a response. Additional details regarding the response synthesis system 100 selecting experience data from data tables associated with widgets are provided below with respect to FIG. 2. Further details and examples of graphical user interfaces for displaying experience data within widgets and selecting experience data based on selections within the widgets are provided below with respect to FIGS. 8A-8B.

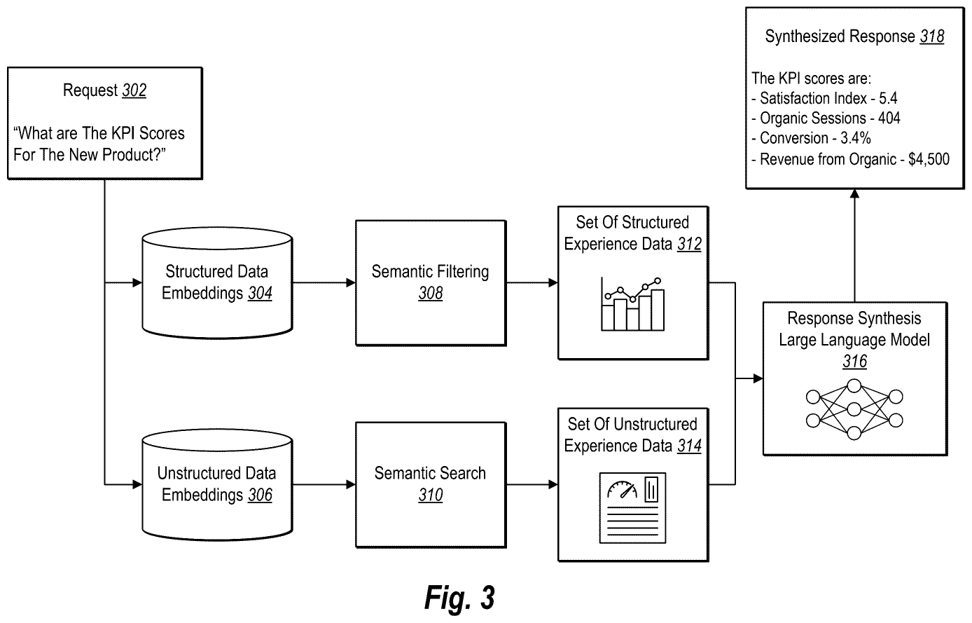

In some embodiments, the response synthesis system 100 selects experience data based on semantic similarity between the experience data and the request to synthesize a response. In particular, the response synthesis system 100 generates a semantic similarity between data embeddings and the response and selects embeddings based on the semantic similarity. For example, based on semantic similarity, the response synthesis system 100 filters experience data or conducts a semantic search of experience data to identify and/or retrieve experience data with concepts or entities where the ideas, contexts, or intents align with the request to synthesize the response. Additional details regarding the response synthesis system 100 selecting experience data based on semantic similarity are provided below with respect to FIG. 3.

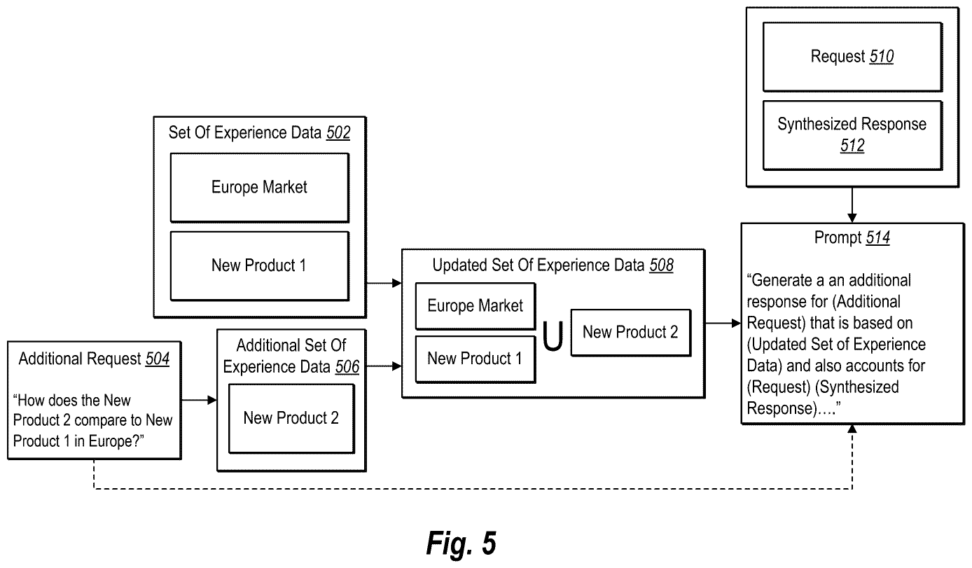

As previously mentioned, the response synthesis system 100 selects experience data for response synthesis large language model 106 to generate synthesized response 108. In one or more embodiments, in response to receiving an additional request to synthesize an additional response, the response synthesis system 100 generates an updated set of experience data for the large language model to synthesize the additional response. Specifically, the response synthesis system 100 receives an additional request to synthesize an additional response based on the previous synthesized responses and, in response, generates an updated set of experience data that includes data from the previously synthesized response and data selected for the additional request to provide in a prompt for the large language model. The response synthesis system 100 generates the updated set of experience data by performing data unification of a set of experience data selected for a request and an additional set of experience data selected for an additional request. In some instances, the response synthesis system 100 performs data unification between various sets of experience data (e.g., corresponding to previous requests) to generate the updated set of experience data. Additional details regarding the response synthesis system 100 generating an updated set of experience data based on receiving an additional request to synthesize a response are provided below with respect to FIG. 5.

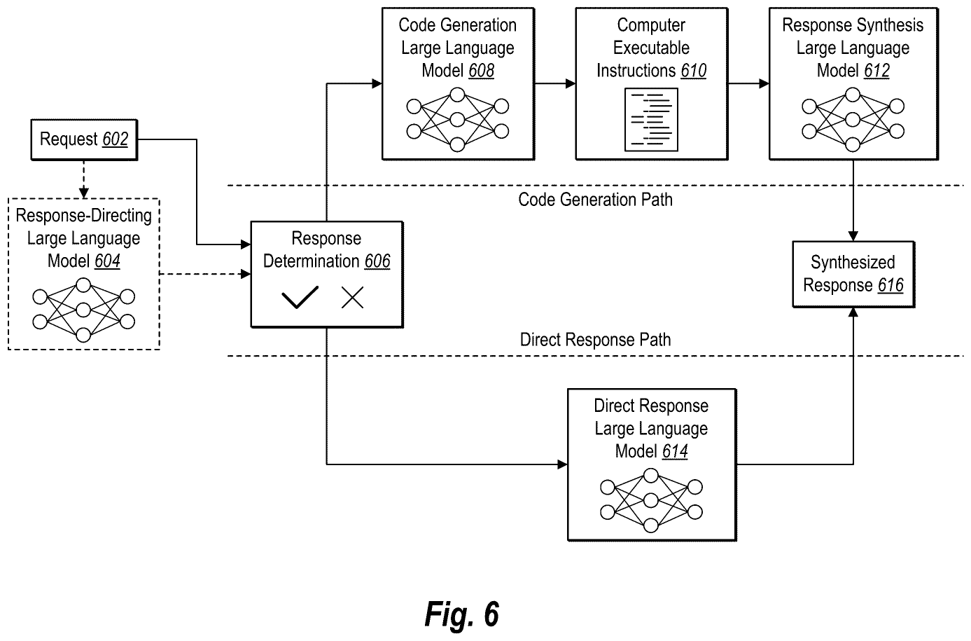

As previously mentioned, the response synthesis system 100 utilizes large language models to synthesize responses using experience data. In some embodiments, the response synthesis system 100 utilizes multiple large language models to synthesize a single response. In particular, the response synthesis system 100 analyzes a request to synthesize a response and determines whether additional computations are required to synthesize a response. If the response synthesis system 100 determines that mathematical computations are required to synthesize a response, the response synthesis system 100 can utilize a code generation large language model to generate computer-executable instructions (e.g., code) that is executable by an application or program which can perform the mathematical computations. After executing the computer-executable instructions to perform the mathematical computations, the response synthesis system 100 can utilize the response synthesis large language model 106 to generate synthesized response 108. Additional details regarding the response synthesis system 100 utilizing additional large language models to perform additional computations are provided below with respect to FIG. 6.

The response synthesis system provides a variety of technical advantages relative to conventional systems. For example, by selecting a set of experience data that relates to a request to generate a synthesized response, the response synthesis system 100 improves efficiency relative to conventional systems. Specifically, the response synthesis system 100 maintains databases of data embeddings that the response synthesis system 100 can access upon receiving a request to generate a synthesized response to identify experience data that is semantically similar (or otherwise similar) to the request. The response synthesis system 100 then provides the selected experience data to a large language model to generate a synthesized response, rather than providing all experience data to the response synthesis system 100. The response synthesis system 100 thus reduces the computational requirements and latency of response generation by using the large language model to parse through and process smaller amounts of targeted data, rather than vast databases of generalized information (which also improves accuracy).

In addition, the response synthesis system 100 reduces the number of user interface interactions required to identify information within experience data. Specifically, the response synthesis system 100 provides an experience management interface that includes (within the same interface as graphical data visualizations) a window for a data analysis agent that can receive requests to generate synthesized responses for experience data and displays responses within the data agent. Moreover, the response synthesis system 100 displays source experience data used to generate the synthesized response with a link to access the source experience data, allowing for efficient access to experience data for further research with far fewer user interface interactions than conventional systems. Accordingly, the response synthesis system 100 reduces the number of interactions compared to prior systems for generating or determining insights regarding experience data.

Further, the response synthesis system 100 improves flexibility relative to conventional systems. Specifically, because the response synthesis system 100 utilizes various large language models to synthesize multiple types of responses, the response synthesis system 100 can flexibly respond to many different types of queries regarding experience data, generating intelligent insights rather than (or in addition to) simple descriptions. For example, by identifying semantically similar experience data and using a response synthesis large language model to analyze the request and the experience data, the response synthesis system 100 can respond to a myriad of queries in a request rather than simply performing a limited set of predefined actions programmed into a system. Further, the response synthesis system 100 can also identify and respond when a request requires mathematical computations that large language models are generally unable to perform accurately in prior systems. To do so (either as a standalone response or as part of a larger response), the response synthesis system 100 analyzes requests and identifies requests that require mathematical computations (e.g., averages, high scores, low scores) and utilizes a code generation large language model to generate computer-executable instructions to perform the mathematical computations.

Moreover, the response synthesis system 100 improves accuracy relative to conventional systems. For example, as mentioned, the response synthesis system 100 selects a set of experience data that is semantically similar to the request (e.g., based on comparing embeddings in an embedding space) and provides that to a response synthesis large language model to generate a synthesized response. Because the response synthesis system 100 identifies relevant experience data before providing it to a response synthesis large language model, the response synthesis system 100 generates more accurate, more efficient responses than conventional systems which generate responses on vast amounts of overgeneralized data. Moreover, because the response synthesis system 100 can select experience data based on filters, the response synthesis system 100 can generate responses that are specific to a user query rather than selecting from or analyzing large amounts of irrelevant, generic information.

As illustrated by the foregoing discussion, the present disclosure utilizes a variety of terms to describe the features and advantages of the response synthesis system. Additional details regarding the meaning of such terms are now provided. For example, as used herein, the term “experience data” refers to a collection of scores, text, or other data that contains information about an experience of a user. In particular, the term “experience data” refers to information or data of a user experience with a system, product, good, service, platform, or event. In some embodiments, experience data comprises a survey response or set of survey responses or data extrapolated from survey responses from users of the system. In other embodiments, experience data can comprise data from sources in which a user may express their thoughts about their experience with a system, such as app reviews or social media. In addition, experience data can include data corresponding to an experience journey of a user, such as data corresponding to interactions with a product, experience, good, or service. To illustrate, experience data can include, but is not limited to, a transcript from a phone call, text from an email or email exchange, social media text or data indications, messaging application interactions, data corresponding to web page views, data generated from mobile application usage, responses to structured questions of a digital survey, or responses to an open-ended question of a digital survey.

Relatedly, as used herein, the term “structured experience data” refers to experience data that is stored (or organized) in a predefined structured format. In particular, the term structured experience data refers to experience data stored in data tables. For example, structured experience data is stored in data tables associated with widgets of an experience management system that allows for access, organization, and display of the structured experience data. In some instances, structured experience data refers to data obtained from responses to digital survey questions, such as answers to closed-ended survey questions (e.g., a digital survey question where a respondent selects from preselected options or answers).

In addition, as used herein, the term “unstructured experience data” refers to experience data that does not have a predefined format or cannot easily be organized into rows and columns. Specifically, unstructured experience data refers to experience data in which a respondent can express an opinion freely through various communications. For example, unstructured experience data refers to text, images, audio files, social media posts, or responses to an open-ended question of a digital survey. In some cases, unstructured experience data is stored in (or associated with) comment widgets of an experience management system.

Furthermore, as used herein, the term “large language model” (LLM) refers to one or more machine learning models trained to perform computer tasks to generate or identify content items in response to trigger events (e.g., user interactions, such as text queries and button selections). In particular, a large language model can be a neural network (e.g., a deep neural network or a transformer neural network) with many parameters trained on large quantities of data (e.g., unlabeled text) using a particular learning technique (e.g., self-supervised learning). For example, a large language model can include parameters trained to generate outputs (e.g., block content elements) based on prompts and/or to identify content items based on various contextual data, including graph information from a knowledge graph and/or historical user account behavior. In some cases, a large language model comprises a GPT model such as, but not limited to, ChatGPT. Relatedly, the term “response synthesis large language model” refers to a large language model trained or tuned to generate an output based on a given prompt or input. Moreover, the term “code generation large language model” refers to a large language model trained or tuned to generate computer-executable instructions based on a given prompt or to provide a specific output.

As used herein, the term “machine learning model” refers to a computer algorithm or a collection of computer algorithms that automatically improve for a particular task through iterative outputs or predictions based on the use of data. For example, a machine learning model can utilize one or more learning techniques to improve accuracy and/or effectiveness. For example, machine learning models include various types of neural networks, decision trees, support vector machines, linear regression models, and Bayesian networks. In some embodiments, the morphing interface system utilizes a large language machine-learning model in the form of a neural network.

Relatedly, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., responses, computer code, or embeddings) based on a plurality of inputs provided to the neural network. In some cases, a neural network refers to an algorithm (or set of algorithms) that implements deep learning techniques to model high-level abstractions in data. A neural network can include various layers, such as an input layer, one or more hidden layers, and an output layer, each of which performs tasks for processing data. For example, a neural network can include a deep neural network, a convolutional neural network, a transformer neural network, a recurrent neural network (e.g., an LSTM), a graph neural network, or a generative adversarial neural network. Upon training, such a neural network may become a large language model.

Also, as used herein, the term “semantic similarity” refers to a measure of similarity that quantifies the degree to which two pieces of text (or other data) convey related concepts. In particular, the term semantic similarity refers to a metric that reflects the degree of similarity between pieces of text. For example, semantic similarity can convey the similarity between concepts identified in words, sentences, large selections of text, or documents. In some cases, a semantic similarity is measured using a cosine similarity, a Euclidean distance, a Manhattan distance, a Jaccard similarity, or a Pearson correlation coefficient.

As used herein, the term “response category” refers to a group or classification for a synthesized response from a large language model. In particular, the term response category refers to a group or classifications for experience data that include shared characteristics, attributes, or criteria of experience data. For example, a response category can be a predefined classification for experience data. In addition, a response category can include a specific style, format, or purpose for the output of a large language model synthesizing a response for experience data of the response category. To illustrate, a response category can be summarization, key drivers, score recall, benchmark, trend, demographic differences, or action advice.

In addition, as used herein, the term “data analysis agent” refers to a digital tool that performs actions based on user input. Specifically, the term “data analysis agent” refers to a software piece that performs actions performs tasks, provides information, or streamlines workflows based on user input. For example, upon receiving a user input, a data analysis agent can select and process information into responses for the user input. In some instances, a data analysis agent is displayed as a part of a graphical user interface that can receive user input and display responses corresponding to the user input. In addition, a data analysis agent can utilize machine-learning models, natural language processing, or other artificial intelligence to analyze user input and/or generate responses based on user input.

As previously mentioned, the response synthesis system 100 selects a set of experience data to provide a response synthesis large language model to generate a synthesized response. Specifically, the response synthesis system 100 selects the set of experience data based on comparing data embeddings extracted from the experience data to a request to synthesize a response. FIG. 2 illustrates a schematic diagram of the response synthesis system 100 selecting a set of experience data based on comparing a request to generate a synthesized response to data embeddings extracted from experience data in accordance with one or more embodiments.

As shown in FIG. 2, the response synthesis system 100 accesses structured experience data 206 that is stored in structured experience database 204 associated with tabular widgets 202. Specifically, structured experience data 206 includes experience data from various sources of digital feedback that can be organized into structured data storage. For example, structured experience data 206 can include responses to closed-ended questions of digital surveys that limit respondents to a set of pre-determined answers, such as yes/no questions, multiple choice questions, rating scales, or checkboxes. Structured experience data 206 can also include experience data corresponding to experience journeys of a user, such as interactions with a product, experience, or service.

As mentioned, tabular widgets 202 store (or are associated with) structured experience data 206. In one or more embodiments, tabular widgets 202 display structured experience data 206 within a tabular widget based on user input. Specifically, tabular widgets 202 are interactive elements within a graphical user interface of an experience management system that allow users to access and interact with structured experience data 206. For example, tabular widgets 202 include controls, displays, or tools to select and/or display structured experience data 206 according to user selections of structured experience data 206. As an illustration, based on user selections indicating “North American Offices” and “Satisfaction,” a tabular widget displays structured experience data 206 that corresponds to the user selections.

In some embodiments, tabular widgets 202 can store structured experience data 206 associated with digital survey questions in data tables of structured experience database 204 associated with the tabular widgets 202. In particular, the response synthesis system 100 (or the experience management system 904) aggregates responses to a digital survey from a multitude of respondents into data tables to generate structured experience data 206. For example, the response synthesis system 100 (or the experience management system 904) adds experience data into data tables corresponding to a digital survey. As an illustration, the response synthesis system 100 (or the experience management system 904) maps responses of a digital survey to a data table and adds experience data to the data table.

As also shown in FIG. 2, the response synthesis system 100 accesses unstructured experience data 212 that is stored in unstructured experience database 210 associated with comment widgets 208. In one or more embodiments, comment widgets 208 store unstructured experience data 212 in data storage associated with comment widgets 208. In particular, unstructured experience data 212 includes unstructured text from various digital feedback sources. For example, unstructured experience data can include text responses to an open-ended question of a digital survey, data or text extracted from a web page or social media post, text of an electronic communication, or unstructured text (e.g., a transcript) from an audio or video communication. In some cases, the response synthesis system 100 (or the experience management system 904) stores unstructured experience data 212 in databases, data lakes, or data warehouses associated with comment widgets 208.

As just mentioned, comment widgets 208 store (or are associated with) unstructured experience data 212. In addition, in one or more embodiments, comment widgets 208 display unstructured experience data 212 based on user input. In particular, comment widgets 208 are interactive elements within a graphical user interface of an experience management system that allow users to access and interact with unstructured experience data 212. For example, comment widgets 208 include various controls, displays, or tools to select and/or display unstructured experience data 212 according to user selections of unstructured experience data 212. As an illustration, based on user selections of options to view responses to a question of a digital survey, a comment widget displays the text responses to the question. As another illustration, based on a user selection of a topic, a comment widget displays text responses corresponding to the topic.

As previously mentioned, the response synthesis system 100 generates data embeddings from experience data. In particular, as shown in FIG. 2, the response synthesis system 100 generates structured data embeddings 216 from structured experience data 206 and unstructured data embeddings 220 from unstructured experience data 212. For example, the response synthesis system 100 extracts structured data embeddings 216 from structured experience data 206 representing instances of structured experience data in a vector space and stores the structured data embeddings 216 in the structured experience database. Similarly, the response synthesis system 100 extracts unstructured data embeddings 220 from unstructured experience data 212 representing instances of unstructured experience data in a vector space and stores the unstructured data embeddings 220 in the unstructured data embedding database. In some instances, the response synthesis system 100 generates structured data embeddings 216 and/or unstructured data embeddings by extracting metadata from data storage associated with the widgets storing the experience data. As an illustration, the response synthesis system 100 extracts information (e.g., widget titles, first column information) and concatenates it into a single string from which the response synthesis system 100 extracts an embedding.

In addition, in one or more embodiments, the response synthesis system 100 maintains a structured data embedding database 214 and an unstructured data embedding database 218. Specifically, the response synthesis system 100 extracts structured data embeddings 216 from structured experience data 206 and extracts unstructured data embeddings 220 from unstructured experience data 212 at various points after receiving experience data to generate structured data embedding database 214 and unstructured data embedding database 218.

Upon receiving request 222 to synthesize a response, the response synthesis system 100 accesses structured data embeddings 216 in structured data embedding database 214 and/or unstructured data embeddings 220 in unstructured data embedding database 218 to compare to request 222. In some embodiments, the response synthesis system 100 utilizes an embedding-generating machine learning model to generate the data embeddings upon receiving structured experience data or unstructured experience data. For example, the response synthesis system 100 can utilize the embedding-generating machine learning model to generate data embeddings upon receiving an indication of completion of a digital survey and receiving experience data associated with the survey. In other embodiments, the response synthesis system 100 generates embeddings at predefined interval times (e.g., once a day) using experience data added since a previous interval. Indeed, by generating and storing data embeddings, the response synthesis system 100 is able to quickly identify and select experience data to provide to response synthesis large language model 226.

As mentioned, the response synthesis system 100 selects a set of experience data 224 to provide to response synthesis large language model 226 to generate synthesized response 228. Specifically, the response synthesis system 100 compares request 222 to structured data embeddings 216 and unstructured data embeddings 220 to select set of experience data 224. For example, the response synthesis system 100 generates a data embedding from request 222 to compare to structured data embeddings 216 and/or unstructured data embeddings 220. In some cases, the response synthesis system 100 generates a similarity metric that quantifies a semantic similarity between request 222 and structured data embeddings 216 and/or between request 222 and unstructured data embeddings 220. Additional details regarding the response synthesis system 100 generating semantic similarity metrics are provided below with respect to FIG. 3.

In some embodiments, the response synthesis system 100 selects the set of experience data 224 by selecting widgets to provide to response synthesis large language model 226. In particular, the response synthesis system 100 identifies widgets from tabular widgets 202 and/or comment widgets 208 that correspond to request 222 and provides the widgets in a prompt for response synthesis large language model 226. The response synthesis system 100 can provide the widget by formatting the widget for response synthesis large language model 226. For example, the response synthesis system 100 can encapsulate the properties, configuration, and content of the widget using hierarchical tags (e.g., an XML-like structure). In some cases, rather than providing an entire widget to response synthesis large language model 226, the response synthesis system 100 identifies data within a widget that corresponds to request 222 and provides a portion of a widget to response synthesis large language model 226.

As previously mentioned, the response synthesis system 100 selects experience data based on semantic similarity. In particular, the response synthesis system 100 generates semantic similarities between a request to synthesize and response and data embeddings and selects experience data based on the semantic similarity. FIG. 3 illustrates a schematic diagram of a response synthesis system selecting experience data based on semantic similarity between a request and data embeddings associated with the experience in accordance with one or more embodiments.

As illustrated in FIG. 3, the response synthesis system 100 receives request 302 to synthesize a response using experience data. Specifically, request 302 can include a text request to synthesize a specified response. For example, request 302 can include a request to generate a summary, identify information, or provide suggestions based on experience data. In some cases, the response synthesis system 100 receives the request by receiving text input from a client device associated with a user account of an experience management system. In other cases, the response synthesis system 100 receives a selection of an option to synthesize a response corresponding to the option. For example, a summary option would generate a request to synthesize a summary from experience data, an action item option would generate a request to synthesize a suggested action item based on experience data, and a trend option would generate a request to synthesize trends from experience data.

As also shown in FIG. 3, the response synthesis system 100 compares request 302 to structured data embeddings 304 and unstructured data embeddings 306. In particular, the response synthesis system 100 generates a response data embedding corresponding to request 302 and compares the response data embedding to structured data embeddings 304 and unstructured data embeddings 306 to generate semantic similarity metrics. For example, semantic similarity metrics quantify a semantic similarity between request 222 and data embeddings of structured data embeddings 304 and/or unstructured data embeddings 306.

In one or more embodiments, the response synthesis system 100 generates a similarity metric by generating semantic cosine distance between the data embedding of request 302 and structured data embeddings 304 and/or unstructured data embeddings 306. In some cases, the response synthesis system 100 ranks semantic cosine distances between request 302 and structured data embeddings 304 and, based on the rankings, selects a k number of structured data embeddings 304 (e.g., the k most similar structured data embeddings). The response synthesis system 100 also ranks semantic cosine distances between request 302 and unstructured data embeddings 306 and, based on the rankings, selects an n number of unstructured data embeddings 306 (e.g., the n most similar unstructured data embeddings).

Further, the response synthesis system 100 selects experience data based on the semantic similarity of data embeddings to request 302. Specifically, the response synthesis system 100 selects a set of structured experience data 312 corresponding to the k number of structured data embeddings 304 and/or a set of unstructured experience data 314 associated with the n number of unstructured data embeddings 306. For example, the response synthesis system 100 can select experience data from structured experience data 206 that corresponds to the k embeddings of structured data embeddings 216 based on a semantic similarity metric. Similarly, the response synthesis system 100 can select unstructured experience data from unstructured experience data 212 that corresponds to the top n data embeddings of unstructured data embeddings 220.

In one or more embodiments, the response synthesis system 100 selects the set of structured experience data 312 based on semantic filtering 308. Specifically, the response synthesis system 100 performs semantic filtering 308 to select structured data embeddings from structured data embeddings 304 that are semantically similar to request 302. For example, the response synthesis system 100 performs semantic filtering 308 by generating a semantic similarity metric and identifying structured data embeddings that satisfy a semantic similarity threshold. The response synthesis system 100 then selects the set of structured experience data 312 by selecting experience data corresponding to the structured data embeddings that satisfy the semantic similarity threshold.

In addition, in some embodiments, the response synthesis system 100 selects the set of unstructured experience data 314 based on results of semantic search 310. Specifically, the response synthesis system 100 performs semantic search 310 to identify unstructured data embeddings from unstructured data embeddings 306 that are correlated to the intent and contextual meaning of request 302. For example, the response synthesis system 100 performs semantic search 310 to identify unstructured data embeddings that are semantically similar to request 302. As an illustration, the response synthesis system 100 performs semantic search 310 by generating a plurality of semantic cosine distances, including a semantic cosine distance between a response data embedding and each unstructured data embedding of unstructured data embeddings 306. The response synthesis system 100 ranks the plurality of semantic cosine distances and selects n unstructured data embeddings, then selects the set of unstructured experience data by selecting unstructured experience data corresponding to the n unstructured data embeddings.

As also shown, in one or more embodiments, the response synthesis system 100 provides the set of structured experience data 312 and the set of unstructured experience data 314 to response synthesis large language model 316 to generate synthesized response 318. In particular, the response synthesis system 100 provides the set of structured experience data 312 and the set of unstructured experience data 314 to response synthesis large language model 316 within a prompt. However, in some cases, the response synthesis system 100 provides the set of structured experience data 312 within a prompt (e.g., without the set of unstructured experience data 314). In other cases, the response synthesis system 100 provides the set of unstructured experience data 314 within a prompt (e.g., without the set of structured experience data 312). Indeed, if the response synthesis system 100 determines that the structured data embeddings 304 and/or the unstructured data embeddings 306 do not meet a semantic similarity threshold, the response synthesis system 100 will not include corresponding experience data in a prompt to the response synthesis large language model 316 to generate synthesized response 318.

As mentioned, the response synthesis system 100 provides a set of experience data to a large language model to synthesize a response. In particular, the response synthesis system 100 generates a prompt for a large language model to synthesize a response based on the set of experience data and instructions to generate a synthesized response conforming to a response category. FIG. 4 illustrates a schematic diagram of a response synthesis system generating a prompt comprising a set of experience data and response categories in accordance with one or more embodiments.

As shown in FIG. 4, the response synthesis system 100 provides request 402, a set of experience data 404, and response categories 406 in prompt 408. Specifically, the response synthesis system 100 generates the prompt to include request 402 comprising user input of a request to synthesize a response, a set of experience data 404 corresponding to the request, and instructions to synthesize a response based on the request 402, the set of experience data 404 and to synthesize a response conforming to a response category of response categories 406. In some cases, the response synthesis system 100 generates prompt 408 by adding request 402 and set of experience data 404 to a prompt template. For example, a prompt template can include the instructions and response categories and options for inputting selected experience data and text of a request to generate a synthesized response.

As mentioned, the response synthesis system 100 provides response categories in prompt 408. In particular, the response synthesis system 100 provides response categories indicating a group or classification for a synthesized response for a response synthesis large language model to generate a synthesized response. For instance, prompt 408 can include instructions for a response synthesis large language model to analyze request 402 and determine a response category corresponding to request 402 and generate a synthesized response conforming to the response category.

As shown in FIG. 4, the response synthesis system 100 can include response categories 406 of summarization, key drivers, score recall, benchmark, trend, demographic differences, and action advice. The response synthesis system 100 can include instructions to identify a response category of summarization for request 402 if request 402 includes keywords such as “summary.” For example, a summarization request can be “provide me with a summary of the (team's/departments/business units/company) results.” The response synthesis system 100 can include instructions to identify a response category of key drivers if request 402 includes keywords such as “improve” or indications of drivers such as “engagement,” “well-being,” “inclusion,” “effectiveness,” or “intent to stay.” For example, a key driver request could be “How can I improve the team's engagement?” The response synthesis system 100 can include instructions to identify a response category of score recall if request 402 includes keywords that request identification of certain metrics, such as “what is the” or includes certain metrics. For example, a score recall request can be “What is the team's effectiveness score?” The response synthesis system 100 can include instructions to identify a response category of benchmark if request 402 includes keywords that indicate a comparison, such as “scores compare to” and another category (e.g., company, department). For example, a benchmark request could be “How do our scores compare to the company overall?” The response synthesis system 100 can include instructions to identify a response category of trend if request 402 includes keywords that indicate a comparison of the results over a time period, such as if request 402 includes “compare to” and another time frame (e.g., last year, previous survey). For example, a trend request could be “How do the results compare to last quarter?” The response synthesis system 100 can include instructions to identify a response category of demographic differences if request 402 includes keywords that indicate a demographic breakdown, such as if request 402 includes a demographic group of the experience data and asks for “highest” or “lowest” and a category. For example, a demographic differences request could be “which group has the highest scores for engagement?” The response synthesis system 100 can include instructions to identify an action advice response category if request 402 includes keywords that indicate a request for a suggestion, such as if request 402 includes “action items,” “suggestions,” or “improvements.” For example, an action item request could be “Based on all of my areas of opportunity, what action items can I take to improve the experience of my team?” In some embodiments, the response synthesis system 100 may perform additional actions if request 402 conforms to certain response categories of response categories 406. Specifically, if the response synthesis system 100 determines that request 402 conforms to certain response categories of response categories 406, additional computations are necessary, and the response synthesis system 100 performs additional actions. For example, if the response synthesis system 100 determines that request 402 conforms to response categories of benchmark, trend, or demographic differences that mathematical computations are required to synthesize the request. In some instances, the response synthesis system 100 provides request 402 to a code generation large language model to generate computer-executable instructions to perform mathematical computations. Additional details regarding the response synthesis system 100 providing a request to a code generation large language model are provided below with respect to FIG. 6.

In one or more embodiments, the response synthesis system 100 generates prompts to use in various large language models by selecting prompts from a prompt library. Specifically, because the response synthesis system 100 can utilize various large language models to generate various types of output, the response synthesis system 100 maintains a prompt library comprising prompts for generating various different synthesized responses with the various large language models. For example, the response synthesis system 100 maintains prompts in a prompt library that instruct response synthesis large language model to generate a synthesized response based on experience data and a request, prompts for a response synthesis large language model to generate additional synthesized responses using multiple requests (as described below with respect to FIG. 5), or to generate computer-executable instructions based on a request and a set of experience data.

As previously mentioned, the response synthesis system 100 can generate an updated set of experience data in response to receiving an additional request to generate a synthesized response. In particular, the response synthesis system 100 generates an updated set of experience data that incorporates experience data selected for the additional request and experience data selected for previous requests. FIG. 5 illustrates a schematic diagram of the response synthesis system 100 receiving an additional request to generate a synthesized response generating a prompt with an updated set of experience data in accordance with one or more embodiments.

As shown in FIG. 5, the response synthesis system 100 receives additional request 504. In particular, additional request 504 is a request that the response synthesis system 100 receives after (e.g., secondary to or subsequently to) a request. For example, additional request 504 includes a request clarifying (or posing additional questions about) request 510, a request received prior to additional request 504, a request that requests additional information experience data used in the previous request, or a request that is not associated with the previous request. As an illustration, for request 510, which says, “How does New Product 1 perform in Europe,” additional request 504 could be a request related to the previous request, such as, as illustrated, “How does New Product 2 compare to New Product 1 in Europe?” As another illustration, for a previous request (e.g., request 510) that says, “How does New Product 1 perform in Europe,” additional request 504 could be a request minimally related to the previous request, such as “Where does New Product 1 perform best?” Indeed, additional request 504 is any request received from user input in a client device.

As also illustrated in FIG. 5, the response synthesis system 100 selects an additional set of experience data 506 based on additional request 504. For instance, as described previously (e.g., in relation to FIG. 2 & FIG. 3 above), the response synthesis system 100 compares additional request 504 to structured data embeddings and unstructured data embeddings and selects additional set of experience data 506.

In some embodiments, as illustrated in FIG. 5, the response synthesis system 100 generates updated set of experience data 508 that incorporates an additional set of experience data 506 corresponding to additional request 504 and set of experience data 502 selected to generate synthesized response 512 corresponding to request 510. Specifically, the response synthesis system 100 takes a set-union of set of experience data 502 and additional set of experience data 506. For example, the response synthesis system 100 takes a set union of data by removing duplicate experience data (e.g., experience data that appears in set of experience data 502 and additional set of experience data 506) in updated set of experience data 508. As shown in FIG. 5, the response synthesis system 100 generates updated set of experience data 508 by taking a set union of “Europe Market,” “New Product 1,” and “New Product 2.” Indeed, by providing previous requests and data in a systematic arrangement, the response synthesis system 100 is able to reduce latency and improve efficiency by removing duplicates that are found in multiple sets of experience data selected, particularly for related requests.

As previously mentioned, the response synthesis system 100 selects a set of experience data by selecting widgets, or data tables associated with widgets, to include in a prompt. When generating a set-union of set of experience data 502 and additional set of experience data 506, the response synthesis system 100 computes a set-union between the data tables of the widgets selected to include in the prompt.

In addition, in some embodiments, the response synthesis system 100 generates updated set of experience data 508 from multiple sets of experience data from previous requests. Specifically, the response synthesis system 100 takes a set-union of experience data from multiple sets of experience data from multiple previous requests to generate an updated set of experience data 508 that incorporates experience data from sets of experience data selected for multiple previous requests. For example, upon receiving a further request to generate a synthesized response and selecting a further set of experience data, the response synthesis system 100 can take a set union of the set of the further set of experience data, set of experience data 502, and additional set of experience data 506. However, the response synthesis system 100 can also include a context size limit for how many sets of experience data to include when generating an updated set of experience data. For instance, the response synthesis system 100 can have a context size limit of three previous sets of experience data for which to take a set-union and generate an updated set of experience data.

As also shown in FIG. 5, the response synthesis system 100 generates prompt 514 that includes (information from) updated set of experience data 508, additional request 504, request 510, and synthesized response 512. In particular, the response synthesis system 100 includes instructions in prompt 514 to generate a synthesized response based on additional request 504, updated set of experience data 508, request 510, and synthesized response 512. For example, the response synthesis system 100 includes instructions in prompt 514 to account for request 510 and/or synthesized response 512 when generating a synthesized response for additional request 504.

In one or more embodiments, the response synthesis system 100 generates prompt 514 with a systematic arrangement of previously received requests, previously generated synthesized responses, and updated sets of experience data. For example, for request 510 (e.g., the first request received by the response synthesis system 100), the response synthesis system 100 provides set of experience data 502 and request 510 to generate synthesized response 512. Upon receiving additional request 504 and generating updated set of experience data 508, the response synthesis system 100 generates prompt 514 with the systematic arrangement of data of: request 510, synthesized response 512, updated set of experience data 508, and additional request 504. Further, upon receiving a further request and generating a further updated set of experience data, the response synthesis system 100 generates a prompt with the systematic arrangement of data of: request 510, synthesized response 512, synthesized response to additional request 504, further updated set of experience data, and the further request.

As previously mentioned, in one or more embodiments, the response synthesis system 100 performs additional actions if computations are required to generate a synthesized response. Specifically, when the response synthesis system 100 determines that the mathematical computations are required to generate the synthesized response, the response synthesis system 100 generates computer-executable instructions to perform the mathematical computations. FIG. 6 illustrates a schematic diagram of the response synthesis system 100 utilizing large language models to generate computer-executable instructions to perform mathematical computations for experience data and synthesizing a response using the mathematical computations in accordance with one or more embodiments.

As illustrated in FIG. 6, the response synthesis system 100 generates a response determination 606 for request 602. In particular, when the response synthesis system 100 receives a request to generate a synthesized response, the response synthesis system 100 analyzes request 602 and makes a response determination for request 602. Response determination 606 can indicate whether request 602 requires mathematical computations to generate a synthesized response. For example, the response synthesis system 100 can determine that a response requires mathematical computations if request 602 requests retrieval or top-end scores, bottom-end scores, average scores, or sums of numbers.

In one or more embodiments, the response synthesis system 100 generates a response determination 606 through a binary classification. Specifically, the response synthesis system 100 analyzes request 602 and makes a classification that request 602 does or does not require mathematical computations, such as a “yes” or “no” classification, a “0” or “1,” or a “positive” or “negative” classification. In other embodiments, as shown in FIG. 6, the response synthesis system 100 utilizes a response-directing large language model 604 to generate response determination 606. For instance, the response synthesis system 100 provides request 602 to response-directing large language model 604 in a prompt with instructions to determine if synthesizing a response to request 602 requires mathematical computations.

Additionally, in some embodiments, the response synthesis system 100 generates response determination 606 after selecting a set of experience data for request 602. Specifically, as previously described (e.g., with respect to FIG. 2 & FIG. 3), the response synthesis system 100 compares request 602 to structured data embeddings and unstructured data embeddings to select a set of experience data based on semantic similarity with request 602 and then generates response determination 606. Further, in some instances, the response synthesis system 100 utilizes the set of experience data to generate response determination 606. For example, the response synthesis system 100 provides the set of experience data with request 602 to response-directing large language model 604 to generate response determination 606 based on request 602 and the set of experience data.

In some embodiments, the response synthesis system 100 generates response determination 606 based on a response category for request 602. In particular, if the response synthesis system 100 determines that request 602 aligns with certain response categories, the response synthesis system 100 determines that mathematical computations are required to generate a synthesized response. For example, if the response synthesis system 100 determines that request 602 aligns with response categories of benchmark, trend, or demographic differences, the response synthesis system 100 determines that mathematical computations are required to synthesize a response for request 602. To determine a response category, the response synthesis system 100 can provide request 602 within a prompt to response-directing large language model 604 with response categories and instructions to identify a response category for request 602. If the response-directing large language model determines that request 602 aligns with the response categories of benchmark, trend, or demographic differences, then the response-directing large language model 604 determines that request 602 requires mathematical computations.

As illustrated in FIG. 6, based on response determination 606, the response synthesis system 100 can take a code generation path or a direct response path based on response determination 606. Specifically, the response synthesis system 100 takes a code generation path when response determination 606 indicates that mathematical computations are required to synthesize a response for request 602 and takes a direct response path when response determination 606 indicates that mathematical computations are not required to synthesize a response for request 602. As shown, by taking the code generation path, the response synthesis system 100 determination system provides request 602 and the selected set of experience data to code generation large language model 608 to generate computer-executable instructions 610 that are executable by an application or program that can perform the mathematical computations. The response synthesis system 100 can further use the application to perform the mathematical computations and can provide the result to response synthesis large language model 612 to generate synthesized response 616. By taking the direct response path, the response synthesis system 100 provides request 602 and the selected set of experience data to direct response large language model 614 to generate synthesized response 616.

As mentioned, in some embodiments, the response synthesis system 100 provides request 602 to code generation large language model 608 to generate computer-executable instructions 610. In particular, the response synthesis system 100 provides request 602 and a selected set of experience data to code generation large language model 608 to generate computer-executable instructions that can perform mathematical computations needed to generate a synthesized response for request 602. The response synthesis system 100 generates a prompt for code generation large language model 608 that includes instructions for generating code that executes the type of mathematical computations needed to generate a synthesized response for request 602. In some cases, the response synthesis system 100 determines a type of mathematical computation needed to synthesize a response for request 602 and selects a prompt (or prompt template) from a prompt library that includes instructions to generate computer-executable instructions for the mathematical computations needed. The response synthesis system 100 adds the set of experience data and request 402 to the selected experience data and the request to the prompt and provides the prompt to code generation large language model 608 to generate computer-executable instructions 610. For example, the prompt could include instructions to generate computer-executable instructions 610 that determine an average of experience data (e.g., an average amount sold by a group of employees), identify a high value or low value (e.g., which country had the highest sales, and which country had the lowest sales), or identify trends in data.

In one or more embodiments, the response synthesis system 100 provides an output from executing computer-executable instructions 610 to response synthesis large language model 612 to generate synthesized response 616. Specifically, the response synthesis system 100 executes computer-executable instructions 610 to generate the mathematical computation needed to synthesized response 616. For example, the response synthesis system 100 can execute the computer-executable instructions to determine a value from the mathematical computations needed to generate a synthesized response for request 602. To illustrate, if request 602 requests an average value from experience data, the computer-executable instructions will compute the average value.

After the response synthesis system 100 executes computer-executable instructions 610 to generate a result, the response synthesis system 100 provides the result to the response synthesis large language model 612 to generate synthesized response 616. In particular, the response synthesis system 100 instruct response synthesis large language model 612 to use the results to generate synthesized response 616 for request 602. In some cases, the response synthesis system 100 provides request 602, the set of experience data selected based on request 602, and the results to response synthesis large language model 612 to generate synthesized response 616 based on the results and the set of experience data. In other cases, the response synthesis system 100 provides request 602 and the results to response synthesis large language model 612 with instructions to generate synthesized response 616 using the results.

As previously mentioned, in one or more embodiments, the response synthesis system 100 takes a direct response path when response determination 606 indicates that synthesizing a response for request 602 does not require mathematical computations. For example, the response synthesis system 100 identifies that request 602 includes requests that require synthesis of text, such as a request for a summary, a request to identify action items, or retrieval of a score corresponding to a certain category. The response synthesis system 100 then provides the set of experience data and request 602 to direct response large language model 614 to generate synthesized response 616.

Though depicted as separate large language models, in one or more embodiments, the response-directing large language model 604, the code generation large language model 608, the response synthesis large language model 612, and the direct response large language model 614 utilize the same underlying large language model. For example, the response synthesis system 100 provides different responses to a large language model (e.g., a ChatGPT model) with prompts that instruct the large language model to generate different types of output. However, the response synthesis system 100 can also utilize multiple large language models if, for example, a large language model is unavailable or is performing below a performance threshold (e.g., is providing synthesized responses too slowly).

As previously mentioned, the response synthesis system 100 receives a request to synthesize a response at a data analysis agent of an experience management system. Specifically, the response synthesis system 100 can receive the request and provide the feedback within graphical user interfaces associated with the data analysis agent and/or the experience management system. FIGS. 7A-7B illustrate example graphical user interfaces for receiving a request to generate a synthesized response and for displaying source experience data in accordance with one or more embodiments. Specifically, FIG. 7A illustrates receiving a request to generate a synthesized response within a graphical user interface of the data analysis agent and providing a synthesized response within the graphical user interface. FIG. 7B illustrates displaying source experience data for the synthesized response based on a user interaction with a link within the synthesized response.

As shown in FIG. 7A, the response synthesis system 100 (or the experience management system 904) provide an experience management interface 700 that integrates data analysis agent window, including input option 704 for receiving requests to generate synthesized responses and display window 706 for displaying synthesized responses. The experience management interface 700 also includes a window 702 for displaying experience data associated with a user account of the experience management system. Within window 702, or within other portions of experience management interface 700, the response synthesis system 100 displays tabular widgets associated with structural experience data and/or comment widgets associated with unstructured experience data of the user account.

As mentioned, experience management interface 700 includes input option 704 within which the response synthesis system 100 receives a user input of a request to generate a synthesized response. As shown, in one or more embodiments, the response synthesis system 100 receives a request to generate a synthesized response by receiving a text input of a request to generate a synthesized response. In addition, in some embodiments, experience management interface 700 includes selectable options that, when selected, generate a response corresponding to the option. For example, experience management interface 700 can include a summary option, that when selected, generates a request to synthesize a summary for experience data of the user account. As another example, experience management interface could include options corresponding to the response categories as described above in relation to FIG. 4.

As also mentioned, the response synthesis system 100 displays a synthesized response within display window 706. Specifically, the response synthesis system 100 can display text output of a synthesized response within display window 706. In some cases, the response synthesis system 100 can stream the synthesized response as a response synthesis large language model is synthesizing the response. In other cases, the response synthesis system 100 displays the text of the response when the response synthesis large language model has completed synthesizing a response.

As shown, a synthesized response can include an indication 708 of source experience data used to generate the displayed synthesized response. Specifically, the response synthesis system 100 directs the response synthesis large language model to include indication 708 to the source experience data that the response synthesis large language model used to generate the synthesized response. In some cases, source experience data is the set of experience data that the response synthesis system 100 selected for a prompt for response synthesis large language model to generate a synthesized response. In other cases, the response synthesis large language model identifies source experience data from within the set of experience data and includes indication 708 within synthesized response.

In one or more embodiments, the response synthesis system 100 includes a link to the source experience data in indication 708. Specifically, the response synthesis system 100 identifies the indication of source experience data within the synthesized response and identifies a storage location for the source experience data within the experience management system. The response synthesis system 100 then generates a link to the storage location for the source experience data and provides the link with indication 708 as part of the synthesized response.

As shown in FIG. 7B, based on receiving a user interaction with a link in indication 708, the response synthesis system 100 will update experience management interface 700 to display the source experience data used to generate a synthesized response. For example, as shown, the response synthesis system 100 updates window 702 to include the source experience data. In some cases, the response synthesis system 100 will display a window with the source experience data. In other instances, the response synthesis system 100 displays a widget associated with the source experience data.

As previously mentioned, the response synthesis system 100 can receive additional requests to generate additional synthesized responses. As shown, the response synthesis system 100 can generate and/or display option 710 for generating additional requests. Based on receiving a user interaction with option 710, the response synthesis system 100 generates an additional prompt with an additional request to generate an additional synthesized response based on the synthesized response displayed in display window 706. Specifically, based on a user interaction with option 710, the response synthesis system 100 selects an additional set of experience data associated with the additional request, as described above in relation to FIG. 5. In one or more embodiments, the response synthesis system 100 generates and displays option 710 after displaying a synthesized response within display window 706 (e.g., as options to receive additional requests to generate additional synthesized responses).

As previously mentioned, the response synthesis system 100 selects experience data to provide to a large language model to generate a synthesized response. In one or more embodiments, the response synthesis system 100 selects experience data based on user selections within an experience management interface. FIGS. 8A-8B illustrate example graphical user interfaces for receiving user selections of experience data from which a response synthesis system can select a set of experience data to synthesize a response in accordance with one or more embodiments. Specifically, FIG. 8A illustrates receiving selections for sources of experience data to display within an experience management interface and FIG. 8B illustrates various filters for displaying experience data within an experience management interface.

As illustrated in FIG. 8A, the response synthesis system 100 provides experience management interface 800 displaying experience data. Specifically, the response synthesis system 100 displays experience data associated with a user account associated with experience management interface 800. For example, a user account is associated with experience management interface 800 based on a client device rendering experience management interface 800 or based on a user account logged into a browser rendering experience management interface 800.

In addition, as shown, experience management interface 800 includes option 802 for selecting experience data to display within experience management interface. In particular, the response synthesis system 100 displays experience data corresponding to selections within option 802. For example, as shown, based on the user selections within option 802, the response synthesis system 100 displays reporting data for Jim Smith.

In one or more embodiments, the response synthesis system 100 selects experience data to generate a synthesized response based on selections within option 802. In particular, upon receiving a request to generate a synthesized response, the response synthesis system 100 identifies experience data associated with the selections within option 802 and select a set of experience data from that experience data. For example, the response synthesis system 100 selects widgets shown, or data from widgets shown, from which to select a set of experience data to provide to a response synthesis large language model to generate a synthesized response.

As shown in FIG. 8B, the response synthesis system 100 can also provide option 804 of filters for experience data within experience management interface 800. In particular, based on user selections of filters within option 804, the response synthesis system 100 will display various experience data. The response synthesis system 100 can also select a set of experience data from which to generate a synthesized response based on the selections within option 804. For example, if a certain county is selected as a filter within option 804, the response synthesis system 100 will generate synthesized responses using experience data corresponding to that country.

In one or more embodiments, the response synthesis system 100 displays widgets based on the selections within option 804. Specifically, some of the experience data selections within option 804 are associated with widgets that offer various options for displaying and interacting with experience data. For example, the filters within option 802 render widgets 806 associated with experience data for Qualtrics and for the filters indicated in option 804. As also shown, based on the experience data associated with the selections within option 804, the response synthesis system 100 can display multiple widgets. For instance, if experience data associated with the selections in option 804 is both unstructured experience data and structured experience data, the response synthesis system 100 displays widgets 806 by displaying comment widgets and tabular widgets.

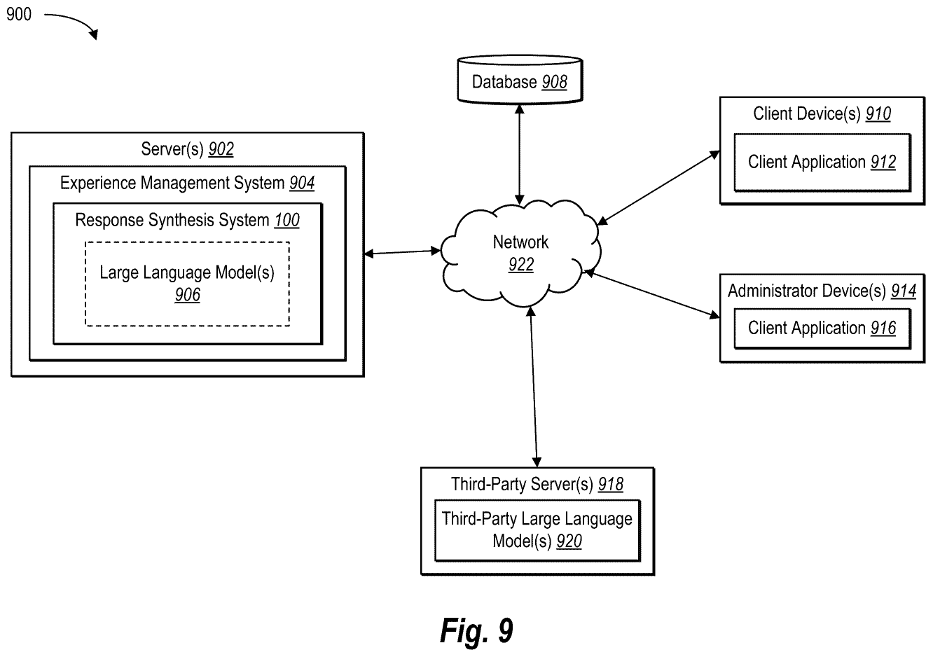

As previously mentioned, the response synthesis system utilizes a large language model to synthesize a response for a request received at a data analysis agent using experience data of an experience management system. In particular, the response synthesis system utilizes various devices, servers, and networks for storing, synchronizing, and communicating regarding content items. FIG. 9 illustrates a schematic diagram of an environment in which an intelligent file mapping system can operate in accordance with one or more embodiments.

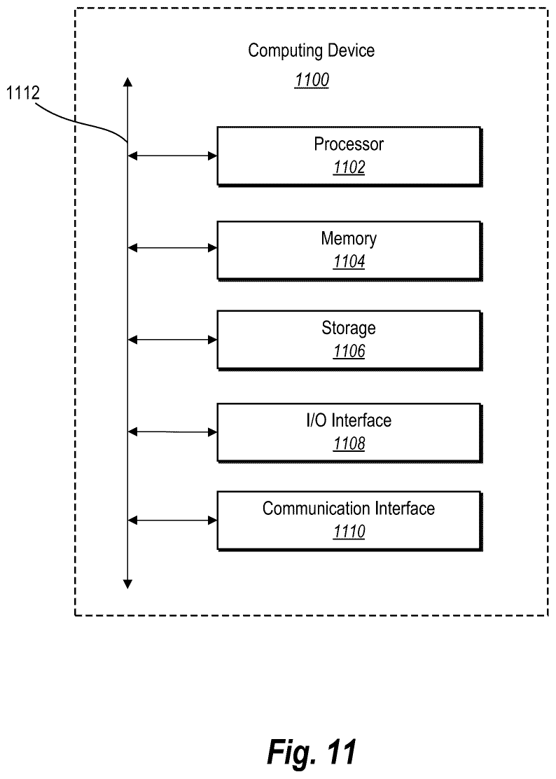

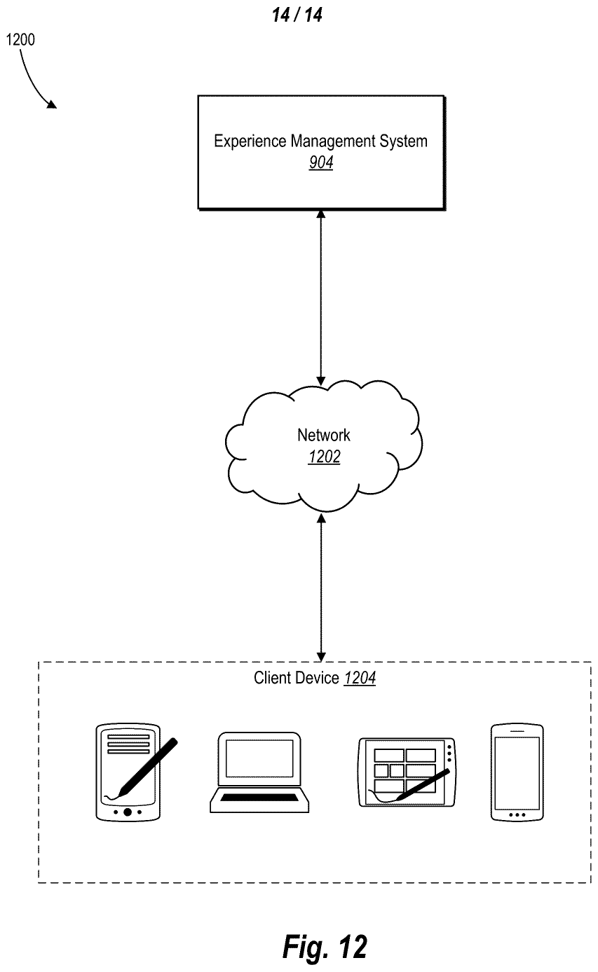

As shown, the environment 900 includes server(s) 902, database 908, client device(s) 910, administrator device(s) 914, and third-party server(s) 918. Each of the components of the environment 900 can communicate via network 922 and network 922 may be any suitable network over which computing devices can communicate. Example networks are discussed in more detail in relation to FIGS. 11-12.

As mentioned above, the environment 900 includes client device(s) 910. The client device(s) 910 can be one of a variety of computing devices, including a smartphone a tablet, a smart television, a desktop computer, a laptop computer, a virtual reality device, an augmented reality device, or another computing device as described in relation to FIGS. 11-12. The client device(s) 910 can communicate with the server(s) 902 via network 922. For example, the client device(s) 910 can receive user input from a user interacting with client device(s) 910 (e.g., via the client application 912) to, for instance, receive user input with a digital survey. In addition, the response synthesis system 100 or the server(s) 902 can receive information relating to various interactions with digital surveys and/or user interface elements based on the input received by the client device(s) 910.

As shown, the client device(s) 910 can include a client application 912. In particular, the client application 912 may be a web application, a native application installed on the client device(s) 910 (e.g., a mobile application, a desktop application, etc.), or a cloud-based application where all or part of the functionality is performed by the server(s) 902. Based on instructions from the client application 912, the client device(s) 910 can present or display information, including a user interface for interacting with digital surveys. Using the client application 912, the client device(s) 910 can perform (or request to perform) various operations, such as displaying digital surveys.

As mentioned above, the environment 900 includes administrator device(s) 914. The administrator device(s) 91 can be one of a variety of computing devices, including a smartphone a tablet, a smart television, a desktop computer, a laptop computer, a virtual reality device, an augmented reality device, or another computing device as described in relation to FIGS. 11-12. The administrator device(s) 914 can communicate with the server(s) 902 via network 922. For example, the administrator device(s) 914 can receive user input from a user interacting with administrator device(s) 914 (e.g., via the client application 916) to, for instance, receive user input selecting experience data or requesting a response (e.g., within a data analysis agent). In addition, the response synthesis system 100 or the server(s) 902 can receive information relating to various interactions with user interface elements (e.g., to interact with experience data) based on the input received by the administrator device(s) 914.

As shown, the administrator device(s) 914 can include a client application 916. In particular, the client application 916 may be a web application, a native application installed on the administrator device(s) 914 (e.g., a mobile application, a desktop application, etc.), or a cloud-based application where all or part of the functionality is performed by the server(s) 902. Based on instructions from the client application 916, the client device(s) 910 can present or display information, including a user interface for interacting with experience data. Using the client application 916, the administrator device(s) 914can perform (or request to perform) various operations, such as displaying experience data (e.g., according to selections of experience data to display).

As also illustrated in FIG. 9, the environment 900 also includes third-party server(s) 918 hosting the third-party large language model(s) 920. In particular, the third-party large language model(s) communicates with the server(s) 902, the client device(s) 910, the administrator device(s) 914, and the database 908 for the response synthesis system 100 to utilize to generate a synthesized response using experience data of a user account of an experience management system. For example, the response synthesis system 100 provides a prompt comprising experience data to third-party large language model(s) 920 to synthesize a response. In some cases, the third-party large language model(s) 920 can refer to various third-party large language models (e.g., ChatGPT, Lambda, Llama, BERT, ROBERTa, Turing-NLG, T5, XLNet). In some embodiments, as shown in FIG. 9, the response synthesis system 100 or the experience management system 904 host large language model 906 and the response synthesis system 100 does not utilize third-party large language model(s) 920. In other embodiments, the response synthesis system 100 utilizes a combination of large language model 906 and third-party large language model(s) 920 to generate synthesized responses, generate computer-executable instructions, or generate response determinations for requests.

As illustrated in FIG. 9, the environment 900 also includes the server(s) 902. The server(s) 902 may generate, track, store, process, receive, and transmit electronic data, such as interactions with interface elements, and/or interactions between user accounts or client devices. For example, the server(s) 902 may receive an indication from the client device(s) 910 of a user interaction providing responses to digital surveys, entering text (e.g., in an email, on a social media post, or other input of unstructured text). In addition, the server(s) 902 can transmit data to the client device(s) 910 in the form of an interface for providing responses to digital surveys. Indeed, the server(s) 902 can communicate with the client device(s) 910 to send and/or receive data via network 922. In some implementations, the server(s) 902 comprise(s) a distributed server where the server(s) 902 include(s) a number of server devices distributed across the network 922 and located in different physical locations. The server(s) 902 can comprise one or more content servers, application servers, container orchestration servers, communication servers, web-hosting servers, machine learning servers, and other types of servers.

As shown in FIG. 9, the server(s) 902 can also include the response synthesis system 100 as part of the experience management system 904. The experience management system 904 can communicate with the client device(s) 910 to perform various functions associated with the client application 912, such as managing user accounts, providing digital surveys, and/or receiving responses to digital surveys. Indeed, experience management system 904 can include a network-based smart cloud storage system to manage, store, and maintain digital surveys and related data across numerous user accounts. In some embodiments, the response synthesis system 100 and/or the experience management system 904 utilize the database 908 to store and access information such as digital survey, responses to digital surveys, and/or experience data associated with a user accounts.

Although FIG. 9 depicts the response synthesis system located on the server(s) 902, in some implementations, the response synthesis system 100 may be implemented by (e.g., located entirely or in part on) one or more other components of the environment. For example, the response synthesis system may be implemented as part of client device(s) 910 and/or a third-party system. As another example, the client device(s) 910 and/or a third-party system can download all or part of the response synthesis system for implementation independent of, or together with, the server(s) 902.

In some implementations, though not illustrated in FIG. 9, the environment 900 may have a different arrangement of components and/or may have a different number or set of components altogether. For example, the client device(s) 910 may communicate directly with the response synthesis system 100, bypassing network 922. The environment 900 may also include one or more third-party systems, each corresponding to a different data source. In addition, the environment 900 can include the database 908 located external to the server(s) 902 (e.g., in communication via the network 922) or located on the server(s) 902 and/or on the client device(s) 910.

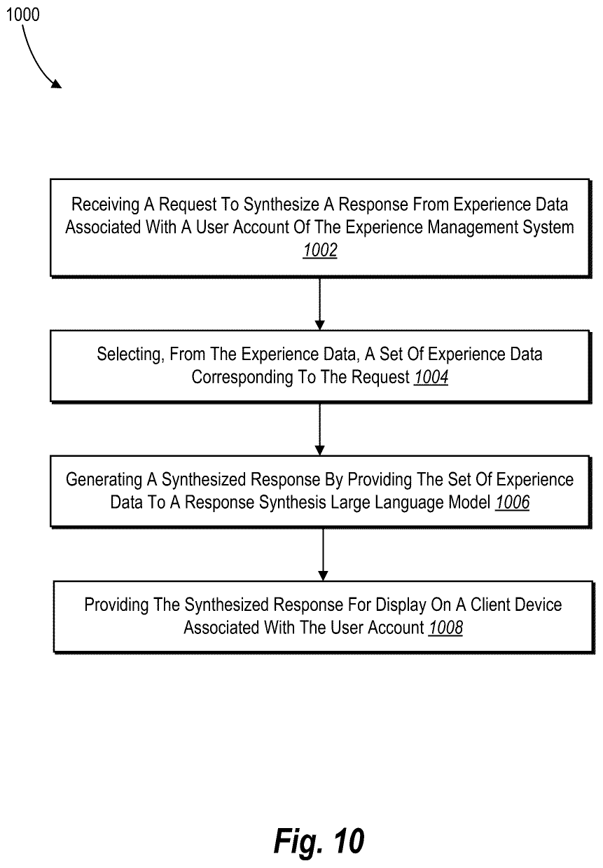

FIGS. 1-9, the corresponding text, and the examples provide a number of different methods, systems, devices, and non-transitory computer-readable media of the response synthesis system. In addition to the foregoing, one or more embodiments can also be described in terms of flowcharts comprising acts for accomplishing a particular result, as shown in FIG. 10. FIG. 10 may be performed with more or fewer acts. Further, the acts may be performed in differing orders. Additionally, the acts described herein may be repeated or performed in parallel with one another or parallel with different instances of the same or similar acts.

As mentioned, FIG. 10 illustrates a flowchart of a series of acts 1000 for utilizing machine learning to synthesize a response for a request received at a data analysis agent using experience data of an experience management system in accordance with one or more embodiments. While FIG. 10 illustrates acts according to one embodiment, alternative embodiments may omit, add to, reorder, and/or modify any of the acts shown in FIG. 10. The acts of FIG. 10 can be performed as part of a method. Alternatively, a non-transitory computer-readable medium can comprise instructions that, when executed by one or more processors, cause a computing device to perform the acts of FIG. 10. In some embodiments, a system can perform the acts of FIG. 10.

As shown in FIG. 10, the series of acts 1000 includes an act 1002 of receiving a request to synthesize a response from experience data associated with a user account of the experience management system, an act 1004 of selecting, from the experience data, a set of experience data corresponding to the request, an act 1006 of generating a synthesized response by providing the set of experience data to a response synthesis large language model, and an act 1008 of providing the synthesized response for display on a client device associated with the user account.

In particular, the act 1002 can include receiving, at a data analysis agent of an experience management system, a request to synthesize a response from experience data associated with a user account of the experience management system, the act 1004 can include in response to receiving the request to synthesize the response, selecting, from the experience data, a set of experience data corresponding to the request, the act 1006 can include generating a synthesized response by providing the set of experience data to a response synthesis large language model, and the act 1008 can include providing the synthesized response for display on a client device associated with the user account.

For example, in one or more embodiments, the series of acts 1000 includes selecting the set of experience data further comprises in response to receiving the request to generate the synthesized response, comparing the request to a plurality of data embeddings extracted from the experience data, and based on comparing the request to the plurality of data embeddings, selecting a set of data embeddings from the plurality of data embeddings.

In addition, in one or more embodiments, the series of acts 1000 includes generating the plurality of data embeddings by extracting metadata from a data table associated with the experience management system that hosts the experience data and generating the plurality of data embeddings using the metadata.

Further, in one or more embodiments, the series of acts 1000 includes wherein selecting the set of experience data further comprises comparing the response to the experience data associated with the user account to determine a plurality of semantic similarities between the experience data and the response and selecting the set of experience data from the experience data based on the plurality of semantic similarities.

Also, in one or more embodiments, the series of acts 1000 includes wherein selecting the set of experience data further comprises selecting, from an unstructured experience database, a portion of unstructured experience data corresponding to the request and selecting, from a structured experience database, a portion of structured experience data corresponding to the request.

Moreover, in one or more embodiments, the series of acts 1000 includes wherein generating the synthesized response by providing the set of experience data to the response synthesis large language model further comprises generating a prompt comprising the set of experience data, a set of response categories, and instructions to generate the synthesized response conforming to a response category of the set of response categories and providing the prompt to the response synthesis large language model to generate the synthesized response.

Additionally, in one or more embodiments, the series of acts 1000 includes wherein providing the synthesized response for display further comprises identifying, within the synthesized response, a storage location within the experience management system storing source experience data used by the response synthesis large language model to generate the synthesized response, generating a link to the storage location within the experience management system, and providing the link to the storage location for display together with the synthesized response within a user interface presented on the client device.

Also, in one or more embodiments, the series of acts 1000 includes generating the plurality of embeddings by generating a plurality of structured data embeddings from structured experience data stored in data tables associated with tabular widgets of the experience management system, and generating a plurality of unstructured data embeddings from unstructured experience data associated with comment widgets of the experience management system, and selecting the set of experience data based on comparing the request to synthesize the response to the plurality of structured data embeddings and the plurality of unstructured data embeddings.

Further, in one or more embodiments, the series of acts 1000 includes receiving, from the client device, an additional request to generate an additional synthesized response, selecting an additional set of experience data from the experience data associated with the user account; generating an updated set of experience data by performing a data unification of the set of experience data and the additional set of experience data, and providing the updated set of experience data to the response synthesis large language model to generate the additional synthesized response.

Additionally, in one or more embodiments, the series of acts 1000 includes utilizing a code generation large language model to generate computer-executable instructions to perform one or more mathematical computations corresponding to the request and using the experience data associated with the user account, generating, based on executing the computer-executable instructions to perform the one or more mathematical computations, a set of mathematical computation responses corresponding to the request, and providing the set of mathematical computation responses and the set of experience data to the response synthesis large language model to generate the synthesized response. Moreover, in one or more embodiments, the series of acts 1000 includes in response to receiving the request to generate the synthesized response, determining if generating the synthesized response requires the one or more mathematical computations, and, based on determining that generating the synthesized response requires the one or more mathematical computations, utilizing the code generation large language model to generate the computer-executable instructions.

Moreover, in one or more embodiments, the series of acts 1000 includes generating a prompt comprising the set of experience data, a set of response categories, and instructions to generate the synthesized response conforming to a response category of the set of response categories and providing the prompt to the response synthesis large language model to generate the synthesized response.

Also, in one or more embodiments, the series of acts 1000 includes providing the synthesized response and the indication of the storage location within a data analysis agent interface of the experience management system.

In addition, in one or more embodiments, the series of acts 1000 includes identifying one or more user selections within a widget of the experience management system indicating selections of experience data and selecting the set of experience data based on the one or more user selections within the widget of the experience management system.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 11 illustrates a block diagram of an example computing device 1100 that may be configured to perform one or more of the processes described above. One will appreciate that one or more computing devices, such as the computing device 1100 may represent the computing devices described above (e.g., server(s) 902, and client device(s) 910, administrator device(s) 914, and third-party server(s) 918). In one or more embodiments, the computing device 1100 may be a mobile device (e.g., a mobile telephone, a smartphone, a PDA, a tablet, a laptop, a camera, a tracker, a watch, a wearable device, etc.). In some embodiments, the computing device 1100 may be a non-mobile device (e.g., a desktop computer or another type of client device). Further, the computing device 1100 may be a server device that includes cloud-based processing and storage capabilities.

As shown in FIG. 11, the computing device 1100 can include one or more processor(s) 1102, memory 1104, a storage device 1106, input/output interfaces 1108 (or “I/O interfaces 1108”), and a communication interface 1110, which may be communicatively coupled by way of a communication infrastructure (e.g., bus 1112). While the computing device 1100 is shown in FIG. 11, the components illustrated in FIG. 11 are not intended to be limiting. Additional or alternative components may be used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 includes hardware for executing instructions, such as those making up a computer program. As an example, and not by way of limitation, to execute instructions, the processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 includes storage for storing data or instructions. As an example, and not by way of limitation, the storage device 1106 can include a non-transitory storage medium described above. The storage device 1106 may include a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as user strokes), receive output from, and otherwise transfer data to and from the computing device 1100. These I/O interfaces 1108 may include a mouse, keypad or a keyboard, a touch screen, camera, optical scanner, network interface, modem, other known I/O devices or a combination of such I/O interfaces 1108. The touch screen may be activated with a stylus or a finger.

The I/O interfaces 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 provides one or more interfaces for communication (such as, for example, packet-based communication) between the computing device and one or more other computing devices or one or more networks. As an example, and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can include hardware, software, or both that connects components of computing device 1100 to each other.

FIG. 12 illustrates an example network environment 1200 of an experience management system 904 (e.g., the experience management system 904, including the response synthesis system 100). The network environment 1200 includes an experience management system 904 and a client device 1204, connected to each other by a network 1202. Although FIG. 12 illustrates a particular arrangement of the client device 1204, the experience management system 904, and the network 1202, this disclosure contemplates any suitable arrangement of the client device 1204, the experience management system 904, and the network 1202. As an example, and not by way of limitation, two or more of the client devices 1204 and the experience management system 904 communicate directly, bypassing the network 1202. As another example, two or more of the client devices 1204 and the experience management system 904 may be physically or logically co-located with each other in whole or in part. Moreover, although FIG. 12 illustrates a particular number of the client device 1204, the experience management system 904, and the network 1202, this disclosure contemplates any suitable number of client devices 1204, experience management systems 904, and networks 1202. As an example, and not by way of limitation, the network environment 1200 may include multiple client devices 1204, multiple experience management systems 904, and multiple networks 1202.

This disclosure contemplates any suitable network 1202. As an example, and not by way of limitation, one or more portions of the network 1202 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. The network 1202 may include one or more networks 1202.

Links may connect the client device 1204 and the experience management system 904 to the network 1202 or to each other. This disclosure contemplates any suitable links. In particular embodiments, one or more links include one or more wireline (such as, for example, Digital Subscriber Line (“DSL”) or Data Over Cable Service Interface Specification (“DOCSIS”)), wireless (such as, for example, Wi-Fi or Worldwide Interoperability for Microwave Access (“WiMAX”)), or optical (such as, for example, Synchronous Optical Network (“SONET”) or Synchronous Digital Hierarchy (“SDH”)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout the network environment 1200. One or more first links may differ in one or more respects from one or more second links.

In particular embodiments, the client device 1204 may be an electronic device including hardware, software, or embedded logic components or a combination of two or more such components and capable of carrying out the appropriate functionalities implemented or supported by the client device 1204. As an example, and not by way of limitation, a client device 1204 may include any of the computing devices discussed above in relation to FIG. 11. A client device 1204 may enable a network user at the client device 1204 to access a network. A client device 1204 may enable its user to communicate with other users at other client devices 1204. A client device 1204 can be the administrator client device(s) 914. A client device 1204 can be the user client device(s) 910. A client device 1204 can include both the administrator client device(s) 914and the client device(s) 910.

In particular embodiments, the client device 1204 may include a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1204 may enter a Uniform Resource Locator (“URL”) or other address directing the web browser to a particular server (such as the server(s) 902), and the web browser may generate a Hyper Text Transfer Protocol (“HTTP”) request and communicate the HTTP request to the server. The server may accept the HTTP request and communicate to the client device 1204 one or more Hyper Text Markup Language (“HTML”) files responsive to the HTTP request. The client device 1204 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

The experience management system 904 may be accessed by the other components of the network environment 1200 either directly or via network 1202. In particular embodiments, the experience management system 904 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the experience management system 904 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable the client device 1204 or the experience management system 904 to manage, retrieve, modify, add, or delete, the information stored in data storage.

In particular embodiments, the experience management system 904 may be capable of linking a variety of entities. As an example, and not by way of limitation, the experience management system 904 may enable multiple users and/or agents to interact with each other or other entities, or to allow users and/or agents to interact with these entities through an application programming interface (“API”) or other communication channels.

In particular embodiments, the experience management system 904 may include a variety of servers, sub-systems, programs, modules, logs, and data stores. In particular embodiments, the experience management system 904 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The experience management system 904 may also include suitable components such as network interfaces, security mechanisms, load balancers, failover servers, management-and-network-operations consoles, other suitable components, or any suitable combination thereof.

In particular embodiments, the experience management system 904 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. Additionally, a user profile may include financial and billing information of users (e.g., customers, etc.).

The web server may include a mail server or other messaging functionality for receiving and routing messages between the experience management system 904 and one or more client devices 1204. An action logger may be used to receive communications from a web server about a user's actions on or off the experience management system 904. In conjunction with the action log, a third-party-content-object log may be maintained of user exposures to third-party-content objects. A notification controller may provide information regarding content objects to the client device 1204. Information may be pushed to the client device 1204 as notifications, or information may be pulled from the client device 1204 responsive to a request received from the client device 1204. Authorization servers may be used to enforce one or more privacy settings of the users of the experience management system 904. A privacy setting of a user determines how particular information associated with a user can be shared. The authorization server may allow users to opt in to or opt out of having their actions logged by the experience management system 904 or shared with other systems, such as, for example, by setting appropriate privacy settings. Third-party-content-object stores may be used to store content objects received from third parties. Location stores may be used for storing location information received from the client devices 1204 associated with users.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

1. A computer-implemented method comprising:
receiving, at a data analysis agent of an experience management system, a request to synthesize a response from experience data stored for a user account of the experience management system in a data table of a database corresponding to a widget associated with the user account wherein the widget is configured to access the experience data from the data table for generating responses to requests associated with the user account;
in response to receiving the request to synthesize the response, selecting, from the experience data, a set of experience data corresponding to the request based on semantic similarities between the request and a plurality of embeddings extracted from the experience data;
generating, utilizing a response synthesis large language model trained using experience data to synthesize responses, a synthesized response by generating a prompt comprising the set of experience data and providing the prompt to the response synthesis large language model; and
providing, for display on a client device associated with the user account, the synthesized response and a link to a storage location within the experience management system storing the set of experience data used by the response synthesis large language model to generate the synthesized response.

2. The computer-implemented method of claim 1, wherein selecting the set of experience data further comprises:
determining, based on comparing the request to the plurality of embeddings, whether to select the set of experience data from:
structured experience data stored for the user account at a structured experience database corresponding with a tabular widget associated with the user account; or
unstructured experience data stored for the user account at an unstructured experience database corresponding to a comment widget associated with the user account; and
based on determining that the request corresponds to the unstructured experience data, selecting the set of experience data from the unstructured experience data or the structured experience data.

3. The computer-implemented method of claim 1, further comprising generating the plurality of embeddings by:
extracting metadata from the data table of the database corresponding to the widget; and
generating the plurality of embeddings using the metadata.

4. The computer-implemented method of claim 1, wherein selecting the set of experience data further comprises:
selecting, from unstructured experience data stored at an unstructured data table of an unstructured experience database corresponding to a tabular widget associated with the user account, a set of unstructured experience data corresponding to the request; and
selecting, from structured experience data stored at a structured data table of a structured experience database corresponding to a comment widget associated with the user account, a set of structured experience data corresponding to the request.

5. The computer-implemented method of claim 4, further comprising:
generating the prompt comprising the set of structured experience data, the set of unstructured experience data, and instructions to generate the synthesized response corresponding to the request based on the set of structured experience data and the set of unstructured experience data; and
generating, utilizing the response synthesis large language model, the synthesized response based on the prompt.

6. The computer-implemented method of claim 1, wherein generating the prompt comprising the set of experience data further comprises:
generating a prompt comprising the set of experience data, a set of response categories, and instructions to generate the synthesized response conforming to a response category of the set of response categories; and
providing the prompt to the response synthesis large language model to generate the synthesized response.

7. The computer-implemented method of claim 1, wherein providing the link to the storage location within the experience management system further comprises:
identifying, within the synthesized response, the storage location within the experience management system storing the set of experience data used by the response synthesis large language model to generate the synthesized response;
generating a link to the storage location within the experience management system; and
providing the link to the storage location for display together with the synthesized response within a user interface presented on the client device.

8. A non-transitory computer-readable medium storing instructions that, when executed by at least one processor, cause a computer system to:
receive, at a data analysis agent of an experience management system, a request to synthesize a response from experience data stored for a user account of the experience management system in a data table of a database corresponding to a widget associated with the user account, wherein the widget is configured to access the experience data from the data table for generating responses to requests associated with the user account;
in response to receiving the request to synthesize the response, select, from the experience data, a set of experience data corresponding to the request based on semantic similarities between a plurality of embeddings extracted from the experience data and the request;
generate, utilizing a response synthesis large language model trained using experience data to synthesize responses, a synthesized response by generating a prompt comprising the set of experience data and providing the prompt to the response synthesis large language model; and
provide, for display on a client device associated with the user account, the synthesized response and a link to a storage location within the experience management system storing the set of experience data used by the response synthesis large language model to generate the synthesized response.

9. The non-transitory computer-readable medium of claim 8, further comprising instructions that, when executed by the at least one processor, cause the computer system to:
generate the plurality of embeddings by:
generating a plurality of structured data embeddings from structured experience data stored in data tables associated with tabular widgets of the experience management system; and
generating a plurality of unstructured data embeddings from unstructured experience data associated with comment widgets of the experience management system; and
select the set of experience data based on comparing the request to synthesize the response to the plurality of structured data embeddings and the plurality of unstructured data embeddings.

10. The non-transitory computer-readable medium of claim 8, further comprising instructions that, when executed by the at least one processor, cause the computer system to:
receive, from the client device, an additional request to generate an additional synthesized response;
select an additional set of experience data from the experience data associated with the user account;
generate an updated set of experience data by performing a data unification of the set of experience data and the additional set of experience data; and
provide the updated set of experience data to the response synthesis large language model to generate the additional synthesized response.

11. The non-transitory computer-readable medium of claim 8, further comprising instructions that, when executed by the at least one processor, cause the computer system to:
utilize a code generation large language model to generate computer-executable instructions to perform one or more mathematical computations corresponding to the request and using the experience data associated with the user account;
generate, based on executing the computer-executable instructions to perform the one or more mathematical computations, a set of mathematical computation responses corresponding to the request; and
provide the set of mathematical computation responses and the set of experience data to the response synthesis large language model to generate the synthesized response.

12. The non-transitory computer-readable medium of claim 11, further comprising instructions that, when executed by the at least one processor, cause the computer system to:
in response to receiving the request to generate the synthesized response, determine if generating the synthesized response requires the one or more mathematical computations; and
based on determining that generating the synthesized response requires the one or more mathematical computations, utilize the code generation large language model to generate the computer-executable instructions.

13. The non-transitory computer-readable medium of claim 8, further comprising instructions that, when executed by the at least one processor, cause the computer system to compare the plurality of embeddings by:
comparing the request to the plurality of embeddings to determine a plurality of semantic similarities between the plurality of embeddings and the response; and
based on comparing the request to the plurality of embeddings, selecting the set of experience data.

14. The non-transitory computer-readable medium of claim 8, further comprising instructions that, when executed by the at least one processor, cause the computer system to:
generate a prompt comprising the set of experience data, a set of response categories, and instructions to generate the synthesized response conforming to a response category of the set of response categories; and
provide the prompt to the response synthesis large language model to generate the synthesized response.

15. A system comprising:
at least one processor; and
at least one non-transitory computer-readable storage medium storing instructions that, when executed by the at least one processor, cause the system to:
receive, at a data analysis agent of an experience management system, a request to generate a synthesized response from experience data stored for a user account of the experience management system in a data table of a database corresponding to a widget associated with the user account wherein the widget is configured to access the experience data from the data table for generating responses to requests associated with the user account;
in response to receiving the request to synthesize the response, select, from the experience data, a set of experience data corresponding to the request based on semantic similarities between the request and a plurality of embeddings extracted from the experience data;
generate, utilizing a response synthesis large language model trained using experience data to synthesize responses, a synthesized response by generating a prompt comprising the set of experience data and providing the prompt to the response synthesis large language model; and
provide, on a client device associated with the user account, the synthesized response and a link to a storage location within the experience management system storing the set of experience data used by the response synthesis large language model to generate the synthesized response.

16. The system of claim 15, further comprising instructions that, when executed by the at least one processor, cause the system to:
generate the link to the storage location within the experience management system storing the set of experience data; and
provide the link to the storage location for display together with the synthesized response.

17. The system of claim 15, further comprising instructions that, when executed by the at least one processor, cause the system to:
generate a prompt comprising the set of experience data, a set of response categories, and instructions to generate the synthesized response conforming to a response category of the set of response categories; and
provide the prompt to the response synthesis large language model to generate the synthesized response.

18. The system of claim 15, further comprising instructions that, when executed by the at least one processor, cause the system to provide the synthesized response and the link to the storage location within a data analysis agent interface of the experience management system.

19. The system of claim 15, further comprising instructions that, when executed by the at least one processor, cause the system to select the set of experience data by:
selecting a set of structured experience data from structured experience data stored in data tables corresponding to tabular widgets of the experience management system; and
selecting a set of unstructured experience data from unstructured experience data stored in data tables corresponding to comment widgets of the experience management system.

20. The system of claim 15, further comprising instructions that, when executed by the at least one processor, cause the system to select the set of experience data by:
identifying one or more user selections within a widget of the experience management system indicating selections of experience data; and
selecting the set of experience data based on the one or more user selections within the widget of the experience management system.
